(19) United States
(12) Patent Application Publication
(10) Pub. No.: US 2025/0309983 A1
(43) Pub. Date: Oct. 2, 2025

(54) RECEIVER AND COMMUNICATION DEVICE

(71) Applicant: NEC Corporation, Tokyo (JP)

(72) Inventors: Masaki AIZONO, Tokyo (JP); Atsushi Kamoi, Tokyo (JP); Fujio Okumura, Kanagawa (JP)

(73) Assignee: NEC Corporation, Tokyo (JP)

(21) Appl. No.: 19/001,947

(22) Filed: Dec. 26, 2024

(30) Foreign Application Priority Data
Mar. 26, 2024 (JP) 2024-049013

(51) Int. Cl. H04B 10/11; H04B 10/60

(52) U.S. Cl. CPC H04B 10/11; H04B 10/60

(57) ABSTRACT

A receiver that includes a ball lens, an annular track disposed surrounding a lower portion of the ball lens, and a movable light receiver including a light receiver movably installed in a direction perpendicular to the annular track. The light receiver includes a communication light receiving element, direction detection light receiving elements disposed annularly with the communication light receiving element, a wavelength filter disposed between the communication light receiving element and a ball lens, and between the plurality of direction detection light receiving elements and a ball lens and passes light in a wavelength band of a spatial optical signal to be communicated, and an optical waveguide that is disposed in association with direction detection light receiving elements and guides the optical signal condensed by the ball lens to the direction detection light receiving element.

This application is based upon and claims the benefit of priority from Japanese Patent Application No. 2024-049013, filed on Mar. 26, 2024, the disclosure of which is incorporated herein in its entirety by reference.

### TECHNICAL FIELD

The present disclosure relates to a receiver and a communication device.

### BACKGROUND ART

In spatial optical communication using signal light (spatial optical signal) propagating in a space, when an incoming direction of a spatial optical signal transmitted from a communication target cannot be accurately grasped, stable communication cannot be performed. Therefore, it is required to accurately adjust the position of the light receiver that receives the spatial optical signal in accordance with the incoming direction of the spatial optical signal. When the position of the light receiver can be accurately adjusted in accordance with the incoming direction of the spatial optical signal, spatial optical communication using the spatial optical signal can be easily established with an any communication target.

PTL 1 (JP 2004-096155) discloses an optical spatial communication device that is installed facing each other between distant points and performs communication using a light beam. The device of PTL 1 has a reception optical system for receiving a light beam from a counterpart device. The reception optical system includes an optical means, one or more photodetectors, and an optical fiber bundle. The optical means condenses the light beam transmitted from the counterpart device on the end face of the optical fiber bundle. The optical fiber bundle is a configuration for transmitting the collected light beam to the photodetector.

According to the method of PTL 1, the incoming direction of the light beam can be analyzed according to the signal intensity of the optical signal condensed via the optical fiber. However, the method of PTL 1 cannot accurately adjust the position of the light receiver in accordance with the incoming direction of the spatial optical signal.

An object of the present disclosure is to provide a receiver and a communication device capable of accurately adjusting a position of a light receiver in accordance with an incoming direction of a spatial optical signal.

### SUMMARY

A receiver according to an aspect of the present disclosure includes a ball lens, an annular track disposed in such a way as to surround a lower portion of the ball lens, and at least one movable light receiver including a light receiver movably installed in a direction perpendicular to the annular track and movably disposed along an outer periphery of the annular track. A light receiver includes a communication light receiving element disposed with a light reception part facing a ball lens, a plurality of direction detection light receiving elements disposed annularly with the communication light receiving element as a center with the light reception part facing the ball lens, a wavelength filter that is disposed between the communication light receiving element and a ball lens, and between the plurality of direction detection light receiving elements and a ball lens and passes light in a wavelength band of a spatial optical signal to be communicated, and an optical waveguide that is disposed in association with the plurality of direction detection light receiving elements and guides the optical signal condensed by the ball lens to the direction detection light receiving element.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a receiver in the present disclosure;

FIG. 2 is a conceptual diagram illustrating an example of a configuration of a receiver in the present disclosure;

FIG. 3 is a conceptual diagram illustrating an example of a configuration of a light receiver in the present disclosure;

FIG. 4 is a conceptual diagram illustrating an example of a configuration of a light receiver in the present disclosure;

FIG. 5 is a conceptual diagram illustrating an example of a configuration of a light receiver in the present disclosure;

FIG. 6 is a conceptual diagram illustrating an example of a configuration of a light receiver in the present disclosure;

FIG. 7 is a conceptual diagram illustrating a configuration example of a direction detection light receiving element in the present disclosure;

FIG. 8 is a conceptual diagram for describing an example of movement of the light receiver supported by the curved support column in the vertical plane in the present disclosure;

FIG. 9 is a conceptual diagram for describing an example of movement of the light receiver supported by the curved support column in the vertical plane in the present disclosure;

FIG. 10 is a block diagram illustrating an example of a configuration of a detection circuit in the present disclosure;

FIG. 11 is a block diagram illustrating an example of a configuration of a detection circuit in the present disclosure;

FIG. 12 is a block diagram illustrating an example of a configuration of a detection circuit in the present disclosure;

FIG. 13 is a block diagram illustrating an example of a configuration of a communication controller in the present disclosure;

FIG. 14 is a conceptual diagram for describing detection of an incoming direction of a spatial optical signal by a direction detection unit in the present disclosure;

FIG. 15 is a conceptual diagram illustrating a display example of detection information indicating a light receiving range of a spatial optical signal by a receiver in the present disclosure;

FIG. 16 is a conceptual diagram illustrating a display example of detection information indicating a light receiving range of a spatial optical signal by a receiver in the present disclosure;

FIG. 17 is a conceptual diagram illustrating an example of a configuration of a receiver in the present disclosure;

FIG. 18 is a conceptual diagram illustrating an example of a configuration of a light receiver in the present disclosure;

FIG. 19 is a conceptual diagram illustrating an example of a configuration of a light receiver in the present disclosure;

FIG. 20 is a conceptual diagram illustrating an example of a configuration of a light receiver in the present disclosure;

FIG. 21 is a conceptual diagram illustrating an example of a configuration of a light receiver in the present disclosure;

FIG. 22 is a conceptual diagram illustrating an example of a configuration of a communication light guide included in a light receiver according to a modification of the present disclosure;

FIG. 23 is a conceptual diagram illustrating an example of a configuration of a communication light guide included in a light receiver according to a modification of the present disclosure;

FIG. 24 is a conceptual diagram illustrating an example of a configuration of an optical waveguide included in a communication light guide included in a light receiver according to a modification of the present disclosure;

FIG. 25 is a conceptual diagram illustrating an example of a configuration of an optical waveguide included in a communication light guide included in a light receiver according to a modification of the present disclosure;

FIG. 26 is a conceptual diagram illustrating an example of a configuration of a communication light guide included in a light receiver according to a modification of the present disclosure;

FIG. 27 is a conceptual diagram illustrating an example of a configuration of a grating element included in a communication light guide included in a light receiver according to a modification of the present disclosure;

FIG. 28 is a conceptual diagram illustrating an example of a configuration of a receiver in the present disclosure;

FIG. 29 is a conceptual diagram illustrating an example of a configuration of a receiver in the present disclosure;

FIG. 30 is a conceptual diagram illustrating an example of a configuration of a horizontal movement mechanism included in a moving support base according to the present disclosure;

FIG. 31 is a conceptual diagram illustrating an example of a configuration of a vertical movement mechanism included in a moving support base according to the present disclosure;

FIG. 32 is a block diagram illustrating an example of a configuration of a communication controller in the present disclosure;

FIG. 33 is a block diagram illustrating an example of a configuration of a communication device in the present disclosure;

FIG. 34 is a conceptual diagram illustrating an example of a configuration of a transmitter in the present disclosure;

FIG. 35 is a block diagram illustrating an example of a configuration of a communication controller in the present disclosure;

FIG. 36 is a conceptual diagram for describing an application of the communication device of the present disclosure;

FIG. 37 is a conceptual diagram illustrating an example of a configuration of a receiver in the present disclosure;

FIG. 38 is a conceptual diagram illustrating an example of a configuration of a receiver in the present disclosure;

FIG. 39 is a conceptual diagram illustrating an example of a configuration of a receiver in the present disclosure; and

FIG. 40 is a block diagram illustrating an example of a hardware configuration that executes control and processing in the present disclosure.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

### First Example Embodiment

First, a receiver according to a first example embodiment will be described with reference to the drawings. The communication device of the present example embodiment is used for optical spatial communication in which signal light (hereinafter, also referred to as a spatial optical signal) propagating in space is transmitted and received. The receiver of the present example embodiment may be used for applications other than optical spatial communication as long as the receiver is used for transmitting and receiving light propagating in a space. The drawings used in the description of the present example embodiment are conceptual and do not accurately depict an actual structure. The light receiving direction of the spatial optical signal is required to be adjusted by a remote operation, an automatic adjustment function, or the like without human intervention. In the present example embodiment, an example in which the light receiving direction of the spatial optical signal is manually changed on the assumption of various use cases will be described.

### (Configuration)

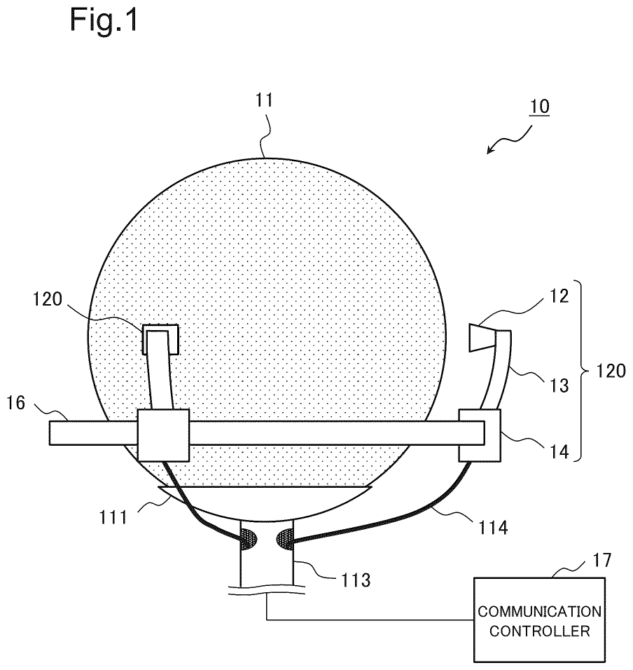

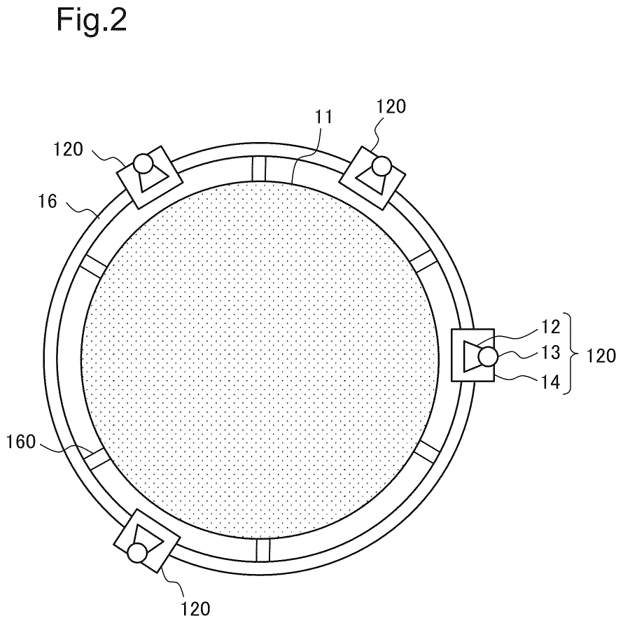

FIG. 1 and FIG. 2 are a conceptual diagram illustrating an example of a configuration of a receiver in the present disclosure. FIG. 1 is a conceptual diagram of a receiver when viewed from a side. FIG. 2 is a conceptual diagram of the receiver when viewed from above. A receiver 10 includes a ball lens 11, a light receiver 12, a curved support column 13, a moving support base 14 and an annular track 16. The receiver 10 may include a communication controller 17. The receiver 10 may include a support base 111 and a support column 113 that support the ball lens 11. Usually, the receiver is housed inside a housing (not illustrated) in which a window for receiving a spatial optical signal is formed.

The light receiver 12, the curved support column 13, and the moving support base 14 constitute a movable light receiver 120. The receiver 10 includes at least one movable light receiver 120. The moving support base 14 is movable along the outer periphery of the annular track 16. The movable light receiver 120 moves along the circumferential direction of the ball lens 11 in accordance with the movement of the moving support base 14 along the outer periphery of the annular track 16. The light receiver 12 is movably installed on a horizontal plane along the circumferential direction of the ball lens 11 with the light receiving face facing the center point of the ball lens 11. In the present example embodiment, the movable light receiver 120 is configured to be manually movable.

The receiver 10 is connected to the communication controller 17. The light receiver 12 is connected to the communication controller 17 via wiring 114. The wiring 114 is connected to the communication controller 17 via the inside of the support column 113. The position where the communication controller 17 is disposed is not particularly limited. For example, the communication controller 17 is disposed in the vicinity of the receiver 10. For example, the communication controller 17 may be constructed as a microcomputer and built in the receiver 10. The communication controller 17 may be implemented in a cloud or a server connected to the receiver 10 via a network such as the Internet.

The ball lens 11 is a spherical lens. The ball lens 11 is an optical element that collects a spatial optical signal coming from the outside. The ball lens 11 has a spherical shape when viewed from an any angle. The ball lens 11 is installed on the support base 111 supported by the support column 113. An annular track 16 is installed around the ball lens 11.

The ball lens 11 collects the incident spatial optical signal. Light (also referred to as a signal light) derived from the spatial optical signal condensed by the ball lens 11 is condensed toward the condensing region of the ball lens 11. Since the ball lens 11 has a spherical shape, the ball lens collects a spatial optical signal coming from an any direction. That is, the ball lens 11 exhibits similar light condensing performance for a spatial optical signal coming from an any direction. The light incident on the ball lens 11 is refracted when entering the ball lens 11. The light traveling inside the ball lens 11 is refracted again when being emitted to the outside of the ball lens 11. Most of the light emitted from the ball lens 11 is collected toward the condensing region.

For example, the ball lens 11 can be made of a material such as glass, crystal, or resin. In the case of receiving a spatial optical signal in the visible region, a material that transmits/refracts light in the visible region can be applied to the ball lens 11. For example, the ball lens 11 can be made of optical glass such as crown glass or flint glass. For example, the ball lens 11 can be made of crown glass such as Boron Kron (BK). For example, the ball lens 11 can be made of flint glass such as Lanthanum Schwerflint (LaSF). For example, the ball lens 11 can be made of quartz glass. For example, the ball lens 11 can be made of crystal such as sapphire. For example, the ball lens 11 can be made of a transparent resin such as acrylic.

In a case where the spatial optical signal is light in a near-infrared region (hereinafter, also referred to as near infrared rays), the ball lens 11 can be made of a material that transmits near infrared rays. For example, in a case of receiving a spatial optical signal in a near-infrared region of about 1.5 micrometers (μm), the ball lens 11 can be made of a material such as silicon in addition to glass, crystal, resin, and the like. In a case where the spatial optical signal is light in the infrared region (hereinafter, also referred to as infrared rays), the ball lens 11 can be made of a material that transmits infrared rays. For example, in a case where the spatial optical signal is an infrared ray, the ball lens 11 can be made of silicon, germanium, or a chalcogenide material. The material of the ball lens 11 is not limited as long as light in the wavelength region of the spatial optical signal can be transmitted/refracted. The material of the ball lens 11 may be appropriately selected according to the required refractive index and use.

The light receiver 12 is vertically movably supported by the curved support column 13 along the circumferential direction of the ball lens 11. The light receiver 12 is vertically movably disposed in the condensing region including the condensing point of the ball lens 11. The light receiver 12 is supported by the curved support column 13 so that the light receiving face always faces the center point of the ball lens 11. The condensing point of the ball lens 11 is not uniquely determined. Therefore, the light receiver 12 is vertically movably disposed along the circumferential direction of the ball lens 11 in the condensing region including the condensing point of the ball lens 11. In the present example embodiment, the light receiver 12 is manually movably disposed.

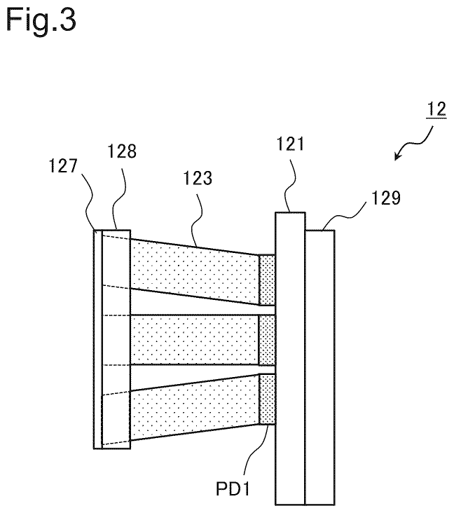

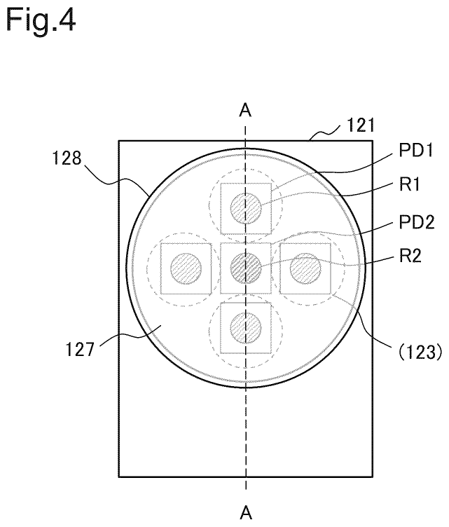

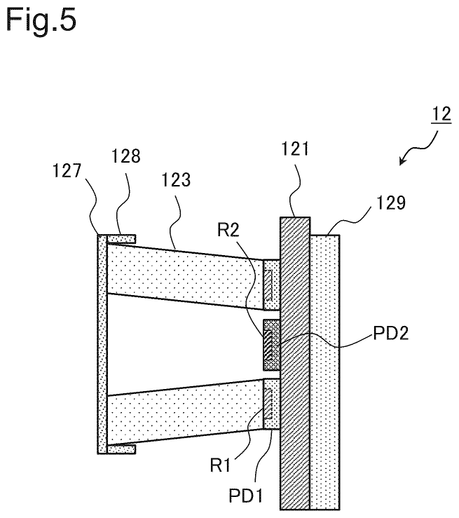

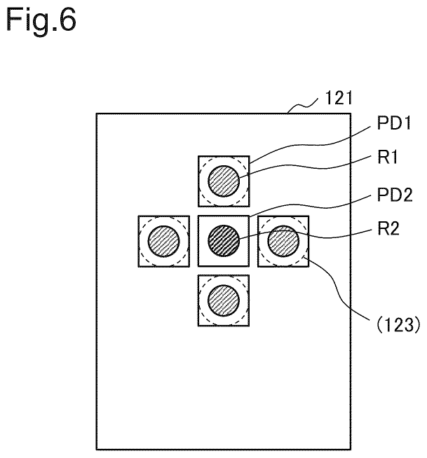

FIGS. 3 to 6 are conceptual diagrams illustrating an example of a configuration of a light receiver in the present disclosure. FIG. 3 is a view of the light receiver when viewed from a side. FIG. 4 is a view of the light receiver when viewed from the ball lens. FIG. 5 is a cross-sectional view illustrating a cross section of the light receiver taken along a cutting line A-A in FIG. 4. FIG. 6 is a view of the light receiver when viewed from the ball lens with some of the components of the light receiver removed. In FIGS. 3 to 6, some components are not illustrated for convenience of description.

The light receiver 12 includes a plurality of direction detection light receiving elements PD1 and a communication light receiving element PD2. The light receiver 12 includes a substrate 121, a wavelength filter 127, a fixing ring 128, and a detection circuit 129. Furthermore, the light receiver 12 includes an optical waveguide 123. In the example of FIGS. 3 to 6, the light receiver 12 includes four direction detection light receiving elements PD1. The four direction detection light receiving elements PD1 are disposed on the concentric circle centered on the communication light receiving element PD2. The number of the direction detection light receiving elements PD1 is not limited to four. The number of the direction detection light receiving elements PD1 may be equal to or more than five.

The plurality of direction detection light receiving elements PD1 and the communication light receiving element PD2 are disposed in the condensing region of the ball lens 11. When viewed from the ball lens 11, the plurality of direction detection light receiving elements PD1 is disposed on the concentric circle centered on the communication light receiving element PD2. A light reception part R1 of the direction detection light receiving element PD1 and a light reception part R2 of the communication light receiving element PD2 are disposed toward the ball lens 11. The plurality of direction detection light receiving elements PD1 and the communication light receiving element PD2 output electric signals related to the received optical signals to the detection circuit 129.

The plurality of direction detection light receiving elements PD1 is disposed on the front face (the left face in FIG. 3) of the substrate 121. The plurality of direction detection light receiving elements PD1 is disposed in a point-symmetric positional relationship with the communication light receiving element PD2 as a center point. The light reception part R1 of the direction detection light receiving element PD1 is directed to the ball lens 11. The direction detection light receiving element PD1 has sensitivity to light in a wavelength band of a spatial optical signal to be communicated. For example, the direction detection light receiving element PD1 is achieved by a photodiode having sensitivity to visible light. For example, the direction detection light receiving element PD1 is achieved by a photodiode having sensitivity to infrared rays. For example, the direction detection light receiving element PD1 is achieved by an indium gallium arsenide InGaAs-based photodiode. In order to accurately measure the position of the communication target, the direction detection light receiving element PD1 is preferably achieved by a photodiode capable of receiving even weak light. When a large photodiode is used, sufficient sensitivity can be obtained even with weak light. However, when a large photodiode is used, the response speed decreases. According to the configuration of the present example embodiment, by using the plurality of direction detection light receiving elements PD1 with the normal size, the position of the communication target can be accurately measured without reducing the response speed.

The output end of the optical waveguide 123 is connected to the light reception part R1 of the direction detection light receiving element PD1. The direction detection light receiving element PD1 receives an optical signal transmitted through the inside of the optical waveguide 123. The optical signal received by the direction detection light receiving element PD1 is converted into an electric signal. The converted electric signal is output to the detection circuit 129.

The communication light receiving element PD2 is disposed on the front face (the left face in FIG. 3) of the substrate 121. The communication light receiving element PD2 is disposed at a center point of a circle formed by the plurality of direction detection light receiving elements PD1. The light reception part R2 of the communication light receiving element PD2 is directed to the ball lens 11 via the wavelength filter 127. For example, the direction detection light receiving element PD1 is achieved by a photodiode having sensitivity to visible light. The communication light receiving element PD2 has sensitivity to light in a wavelength band of a spatial optical signal to be communicated. For example, the communication light receiving element PD2 is achieved by a photodiode having sensitivity to infrared rays. For example, the communication light receiving element PD2 is achieved by an indium gallium arsenide InGaAs-based photodiode.

The light reception part R2 of the communication light receiving element PD2 is directed to the wavelength filter 127. The communication light receiving element PD2 receives the optical signal having passed through the wavelength filter 127. The optical signal received by the light reception part R2 of the communication light receiving element PD2 is converted into an electric signal. The converted electric signal is output to the detection circuit 129.

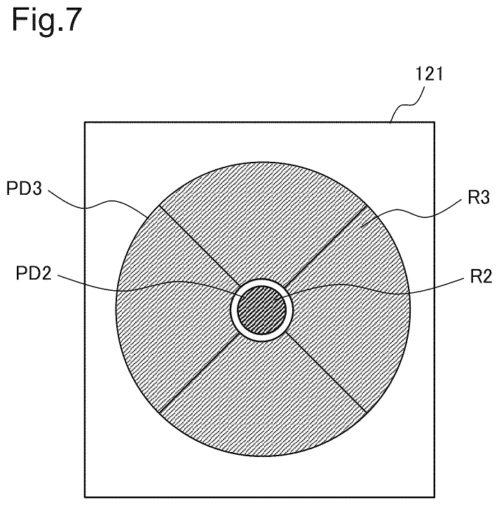

FIG. 7 is a conceptual diagram illustrating a configuration example of a direction detection light receiving element in the present disclosure. FIG. 7 is a view of the light receiver when viewed from the ball lens with some of the components of the light receiver removed. The direction detection light receiving element PD3 includes an annular light reception part R3 surrounding the periphery of the communication light receiving element PD2. A plurality of light receiving regions is formed in the light reception part R3. Each of the plurality of light receiving regions corresponds to the light reception part R1 of the plurality of direction detection light receiving elements PD1 illustrated in FIG. 6 and the like. The electric signal derived from the optical signal received by each of the plurality of light receiving regions is individually output to the detection circuit 129. According to the configuration of FIG. 7, the direction detection light receiving element and the communication light receiving element can be formed on the same plane. According to the configuration of FIG. 7, it is possible to receive the optical signal condensed in the gap formed between the elements of the plurality of direction detection light receiving elements in the configuration of FIG. 6.

The substrate 121 is a printed circuit board. The plurality of direction detection light receiving elements PD1 and the communication light receiving element PD2 are disposed on the front face (the left face in FIG. 3) of the substrate 121. In the example of FIGS. 3 to 6, four direction detection light receiving elements PD1 and one communication light receiving element PD2 are disposed on the front face of the substrate 121. The detection circuit 129 is disposed on the back face (the right face in FIG. 3) of the substrate 121. The detection circuit 129 may be disposed on the front face (the left face in FIG. 3) of or inside the substrate 121.

The optical waveguide 123 is a transmission path that transmits light in a wavelength band of a spatial optical signal to be communicated. The incident end of the optical waveguide 123 is connected to a back face of the wavelength filter 127. The emission end of the optical waveguide 123 is connected to any of the light reception parts R1 of the plurality of direction detection light receiving elements PD1. The optical signal incident on the incident end of the optical waveguide 123 is transmitted through the inside of the optical waveguide 123 and is emitted from the emission end. The optical signal emitted from the emission end is received by the light reception part R1 of the direction detection light receiving element PD1 connected to the optical waveguide 123. For example, the optical waveguide 123 is achieved by an optical fiber made of glass or plastic having high transmittance with respect to light in a wavelength band of a spatial optical signal to be communicated. The optical waveguide 123 may include one optical fiber or a bundle of a plurality of optical fibers. When the wavelength filter 127 is disposed in such a way as to be in contact with the light receiving faces of the direction detection light receiving element PD1 and the communication light receiving element PD2, the emission end of the optical waveguide 123 is connected to the front face of the wavelength filter 127. In this case, the incident end of the optical waveguide 123 is directed to the ball lens 11 without passing through the wavelength filter 127.

The wavelength filter 127 is a wavelength filter through which light in a wavelength band of a spatial optical signal to be received passes. The wavelength filter 127 is disposed in front of the light receiving faces of the plurality of direction detection light receiving elements PD1 and the communication light receiving element PD2 by the fixing ring 128. The front face (the left face in FIG. 3) of the wavelength filter 127 is directed to the ball lens 11. The back face (the right face in FIG. 3) of the wavelength filter 127 is directed to the light receiving faces of the plurality of direction detection light receiving elements PD1 and the communication light receiving element PD2. The incident end of the optical waveguide 123 is connected to a back face of the wavelength filter 127. The wavelength filter 127 passes light in a wavelength band of a spatial optical signal that is to be received by the direction detection light receiving element PD1 and the communication light receiving element PD2. In the portion connected to the optical waveguide 123, the optical signal that has passed through the wavelength filter 127 is received by any of the plurality of direction detection light receiving elements PD1 via the optical waveguide 123. The optical signal that has passed through the wavelength filter 127 in the front portion of the communication light receiving element PD2 is received by the communication light receiving element PD2. The wavelength filter 127 blocks light that is not a reception target. The main purpose of the wavelength filter 127 is to mitigate external light such as sunlight. In an environment less affected by external light, the wavelength filter 127 may be omitted. For example, the wavelength filter 127 may be disposed in such a way as to be in contact with the light receiving faces of the direction detection light receiving element PD1 and the communication light receiving element PD2. In this case, as the wavelength filter 127, a filter that passes light in a wavelength band that is to be received by each of the direction detection light receiving element PD1 and the communication light receiving element PD2 is applied. For example, it is assumed that light in a wavelength band of 900 nm (nanometers) is used for direction detection, and light in a wavelength band of 1550 nm is used for communication. In this case, a filter that passes light of a wavelength band that is to be received by each of the direction detection light receiving element PD1 and the communication light receiving element PD2 is applied.

The fixing ring 128 is a ring-shaped support member. The fixing ring 128 is a member for fixing the plurality of optical waveguides 123 and the wavelength filter 127. The opening of the fixing ring 128 is formed larger than a circle surrounding the outer peripheries of the plurality of direction detection light receiving elements PD1. The material of the fixing ring 128 is not particularly limited. For example, the fixing ring 128 can be made of a material such as metal or plastic. In the example of FIG. 4, the emission end (dashed circle) of the optical waveguide 123 is not in contact with the inner wall of the fixing ring 128. When the wavelength filter 127 is disposed on the light receiving faces of the direction detection light receiving element PD1 and the communication light receiving element PD2, the emission end of the optical waveguide 123 is supported by the inner wall of the fixing ring 128.

The detection circuit 129 is disposed on the back face (the right face in FIG. 3) of the substrate 121. The detection circuit 129 may be disposed on the front face (the left face in FIG. 3) of or inside the substrate 121. The detection circuit 129 receives electric signals output from the direction detection light receiving element PD1 and the communication light receiving element PD2. The signal from the direction detection light receiving element PD1 is used to detect the incoming direction of the spatial optical signal. The signal from the communication light receiving element PD2 is used for communication with the communication target. The detection circuit 129 performs a signal process on the received electric signal. The detection circuit 129 outputs the electric signal subjected to the signal process to the communication controller 17. The electric signal output from the detection circuit 129 is transmitted to the communication controller 17 via the wiring 114.

The curved support column 13 is a hollow column supported by the moving support base 14. The curved support column 13 is curved in a shape along the circumference of the ball lens 11. That is, the curve of the curved support column 13 has an arc shape centered on the center point of the ball lens 11. A slit (not illustrated) opening in the longitudinal direction is formed on a side face of the curved support column 13, the side face facing the ball lens 11. The curved support column 13 movably supports the housing portion of the light receiver 12 along the circumferential direction of the ball lens 11 through the slit. The lower end of the curved support column 13 is fixed to the upper portion of the moving support base 14. In other words, the curved support column 13 is erected on the upper portion of the moving support base 14. The curved support column 13 moves along the circumferential direction of the ball lens 11 in accordance with the movement of the moving support base 14.

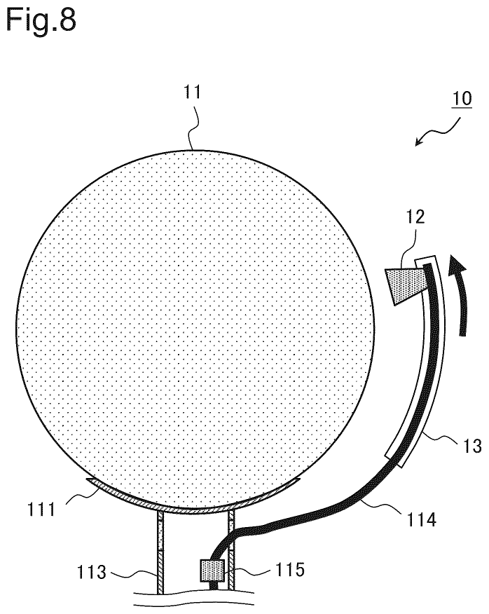

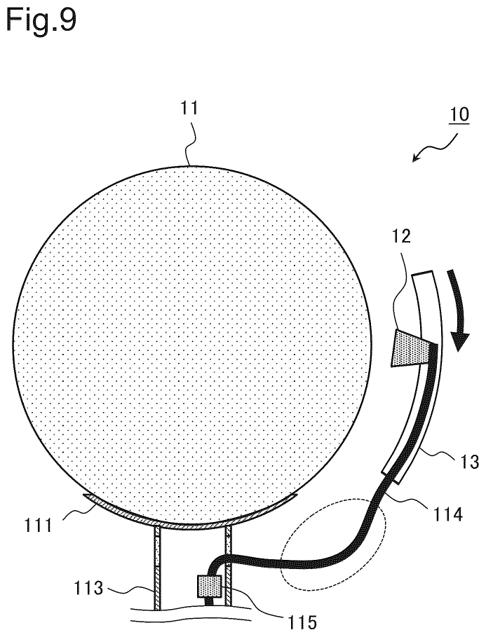

FIGS. 8 to 9 are conceptual diagrams for describing an example of movement of the light receiver supported by the curved support column in a vertical plane in the present disclosure. FIGS. 8 to 9 are cross-sectional views illustrating a cross section of part of the receiver 10. FIG. 8 illustrates an example in which the light receiver reaches the highest position in the vertical plane. FIG. 9 illustrates an example in which the light receiver reaches the lowest position in the vertical plane. The wiring 114 is disposed inside the curved support column 13. The wiring 114 is disposed inside the support column 113 via a hole formed in the support column 113. Part of the wiring 114 is fixed to the inner wall of the support column by a fixture 115. The wiring 114 is made of a flexible member. In the state of FIG. 8, there is no slack in the wiring 114. On the other hand, in the state of FIG. 9, slack occurs as illustrated inside the dotted elliptical frame. As the wiring 114 has slack in this manner, the light receiver 12 can vertically move smoothly.

The moving support base 14 is movably installed at an outer peripheral portion of the annular track 16. The moving support base 14 grips an outer peripheral portion of the annular track 16. The moving support base 14 is movable along the circumferential direction of the annular track 16 in a state of gripping the outer edge portion of the annular track 16. The curved support column 13 is fixed to an upper portion of the moving support base 14. In other words, the curved support column 13 is erected on the upper portion of the moving support base 14. The inside of the moving support base 14 is hollow. The wiring 114 connected to the light receiver 12 passes through the inside of the moving support base 14 and the support column 113 and extends to the communication controller 17.

As described above, the light receiver 12, the curved support column 13, and the moving support base 14 constitute the movable light receiver 120. The receiver 10 includes at least one movable light receiver 120. As the number of movable light receivers 120 increases, the number of communication targets capable of transmitting and receiving spatial optical signals increases. The number of movable light receivers 120 may be set according to the number of communication targets or a communication environment.

The annular track 16 is fixed to the ball lens 11 by a plurality of fixtures 160. The annular track 16 annularly surrounds the lower portion of the ball lens 11. The moving support base 14 is installed at an outer peripheral portion of the annular track 16. The moving support base 14 is movable along the circumferential direction of the annular track 16.

The communication controller 17 acquires an electric signal derived from the optical signal received by the light receiver 12. The communication controller 17 detects the incoming direction of the spatial optical signal according to the electric signal derived from the optical signals received by the plurality of direction detection light receiving elements PD1. The communication controller 17 outputs information including the incoming direction of the detected spatial optical signal. The communication controller 17 decodes a signal derived from the optical signal received by the communication light receiving element PD2. For example, the communication controller 17 causes a transmitter (not illustrated) associated with the receiver 10 to transmit the spatial optical signal according to the content of the decoded signal.

For example, the information including the incoming direction of the spatial optical signal is displayed on a screen of a terminal device (not illustrated) used by an administrator who manages the receiver 10 or an operator who installs the receiver 10. For example, the operator who has confirmed the information related to the incoming direction of the spatial optical signal displayed on the terminal device moves the position of the light receiver 12. The operator moves the light receiver 12 to a position where the intensities of the optical signals received by the plurality of direction detection light receiving elements PD1 are uniform. For example, the operator moves the light receiver 12 in the direction in which the direction detection light receiving element PD1 in which the intensity of the optical signal is high is disposed. The operator moves the light receiver 12 to a position where the intensity of the optical signal received by the communication light receiving element PD2 is maximized, thereby establishing communication with the communication target.

### [Detection Circuit]

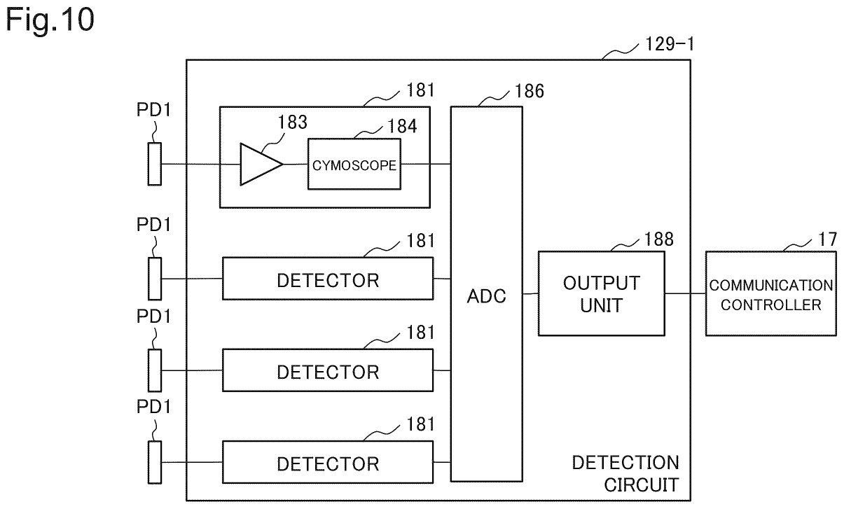

Next, a detailed configuration of the detection circuit in the present example embodiment will be described with reference to the drawings. FIGS. 10 to 12 are block diagrams illustrating an example of a configuration of a detection circuit in the present disclosure. FIGS. 10 to 12 are examples of the configuration of the detection circuit in the present disclosure, and do not limit the configuration of the detection circuit. Processing such as direction detection of the incoming direction of the spatial optical signal based on the optical signal received by the direction detection light receiving element PD1 and decoding of the communication signal based on the optical signal received by the communication light receiving element PD2 is executed in the communication controller 17 in the subsequent stage. The detection circuit may be configured to execute processing such as direction detection of the incoming direction of the spatial optical signal based on the optical signal received by the direction detection light receiving element PD1 and decoding of the communication signal based on the optical signal received by the communication light receiving element PD2.

FIG. 10 is a block diagram illustrating an example of a configuration of a detection circuit in the present disclosure. A detection circuit 129-1 includes a plurality of detectors 181, an analog-to-digital conversion circuit (ADC 186), and an output unit 188 (Analog-to-Digital Converter (ADC)). In the case of the configuration of FIG. 10, the optical signal received by the direction detection light receiving element PD1 is processed by the detection circuit 129-1. On the other hand, the optical signal received by the communication light receiving element PD2 is processed by the communication controller 17 in the subsequent stage.

The plurality of detectors 181 is connected to the plurality of respective direction detection light receiving elements PD1. The detector 181 includes an amplifier 183 and a cymoscope 184. Each of the plurality of detectors 181 may include a band pass filter (BPF) related to a frequency band to be received. The BPF cuts a signal derived from ambient light such as sunlight. The detector 181 may be configured to include a plurality of cymoscopes related to a plurality of frequency bands.

The amplifier 183 is connected to the direction detection light receiving element PD1. An electric signal derived from the signal light received by the direction detection light receiving element PD1 is input to the amplifier 183. The amplifier 183 amplifies the input electric signal with a set amplification factor. For example, by alternating current (AC) operating the amplifier 183, the influence of sunlight can be removed. The amplification factor of the amplifier 183 can be set to any factor. The electric signal amplified by the amplifier 183 is output to the cymoscope 184.

The cymoscope 184 is connected to the amplifier 183. The signal of the modulation frequency to be received amplified by the amplifier 183 is input to the cymoscope 184. The cymoscope 184 detects the input signal. The signal detected by the cymoscope 184 is supplied to the ADC 186. An amplifier may be disposed at a stage subsequent to the cymoscope 184. In this case, the signal detected by the cymoscope 184 is amplified by an amplifier disposed at a stage subsequent to the cymoscope 184 and supplied to the ADC 186.

A signal detected by each of the plurality of cymoscopes 184 is input to the ADC 186. The ADC 186 converts the input signal (analog signal) into a digital signal. The converted digital signal is output to the output unit 188.

The output unit 188 is connected to the ADC 186. The output unit 188 acquires the electric signal converted by the ADC 186. The output unit 188 outputs the acquired electric signal to the communication controller 17. The electric signal converted by the ADC 186 is used to detect the incoming direction of the spatial optical signal.

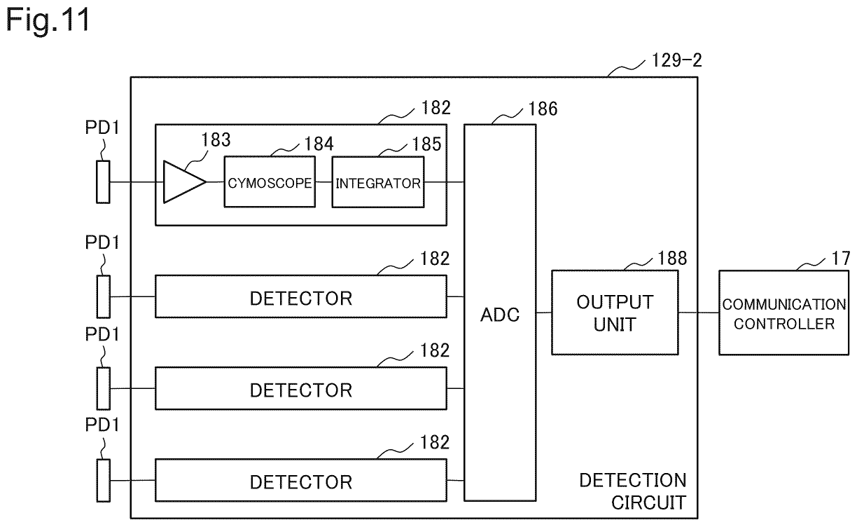

FIG. 11 is a block diagram illustrating an example of a configuration of a detection circuit in the present disclosure. A detection circuit 129-2 includes a plurality of detectors 182, the analog-to-digital conversion circuit (ADC 186), and the output unit 188. The detection circuit 129-2 (FIG. 11) is different from the detection circuit 129-1 (FIG. 10) in the configuration of the detector (detector 182). Differences from the detection circuit 129-1 (FIG. 10) will be described. In the case of the configuration of FIG. 11, the optical signal received by the direction detection light receiving element PD1 is processed by the detection circuit 129-2. On the other hand, the optical signal received by the communication light receiving element is processed by the communication controller 17 in the subsequent stage.

The detector 182 includes an integrator 185 in addition to the amplifier 183 and the cymoscope 184. The integrator 185 integrates the signal having passed through the amplifier 183 and the cymoscope 184 to increase the intensity of the signal. A photodiode capable of high-speed operation has a small light receiving area and a small light receiving intensity of an optical signal. According to the configuration of the detection circuit 129-2 (FIG. 11), since the intensity of the signal can be increased by the integrator 185, a photodiode capable of high-speed operation can be applied to the direction detection light receiving element PD1.

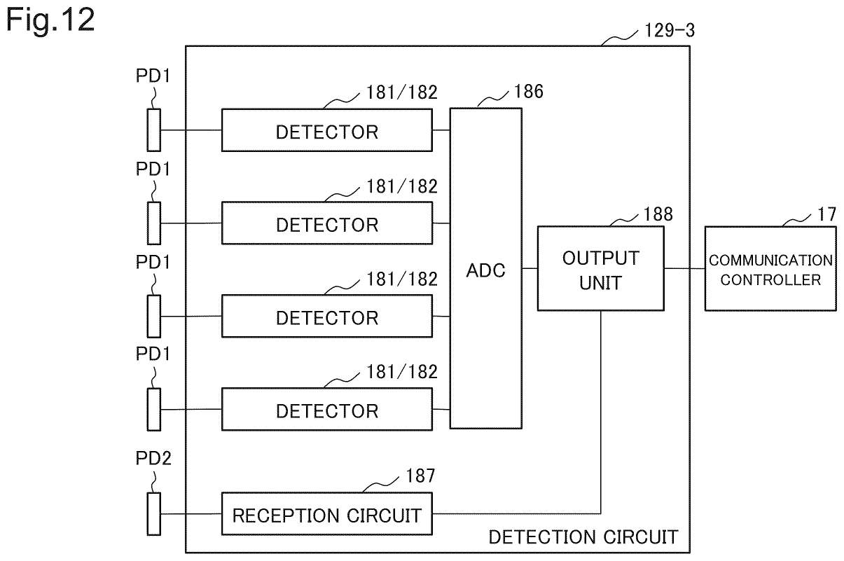

FIG. 12 is a block diagram illustrating an example of a configuration of a detection circuit in the present disclosure. A detection circuit 129-3 includes a plurality of detectors 181 or a plurality of detectors 182, the analog-to-digital conversion circuit (ADC 186), a reception circuit 177, and the output unit 188 (Analog-to-Digital Converter (ADC)). The detection circuit 129-3 (FIG. 12) is different from the detection circuits 129-1 to 2 (FIG. 10, FIG. 11) in that the reception circuit 177 is added. Differences from the detection circuits 129-1 to 2 (FIG. 10, FIG. 11) will be described. In the case of the configuration of FIG. 12, the optical signal received by the direction detection light receiving element PD1 is processed by the detection circuit 129-3. The optical signal received by the communication light receiving element is also processed by the detection circuit 129-3.

The reception circuit 177 is connected to the communication light receiving element PD2. The reception circuit 177 acquires an electric signal derived from the optical signal received by the light reception part R2 of the communication light receiving element PD2. The reception circuit 177 amplifies the acquired electric signal. The reception circuit 177 converts the amplified electric signal from an analog signal to a digital signal. The reception circuit 177 outputs the converted digital signal to the output unit 188. For example, the reception circuit 177 may be provided with a limiting amplifier (not illustrated) before an amplifier (not illustrated). When the limiting amplifier is provided, a dynamic range can be secured. For example, the reception circuit 177 may be provided with a high-pass filter or a band pass filter (not illustrated). The high-pass filter and the band pass filter cut a signal derived from ambient light such as sunlight, and selectively pass a signal of a high frequency component corresponding to a wavelength band of a spatial optical signal.

The output unit 188 is connected to the ADC 186 and the reception circuit 177. The output unit 188 acquires the electric signal converted by the ADC 186. The output unit acquires the electric signal converted by the reception circuit 177. The output unit 188 outputs the acquired electric signal to the communication controller 17. The electric signal converted by the ADC 186 is used to detect the incoming direction of the spatial optical signal. The electric signal converted by the reception circuit 177 is used for communication with a communication target.

### [Communication Controller]

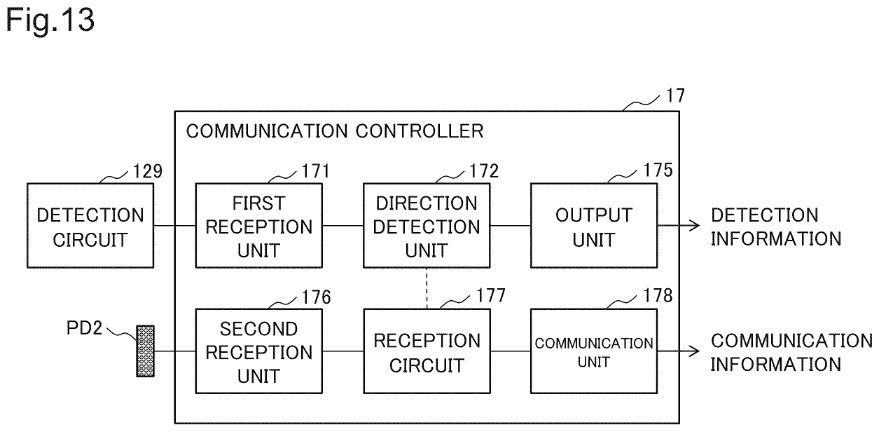

Next, a detailed configuration of the communication controller in the present example embodiment will be described with reference to the drawings. FIG. 13 is a block diagram illustrating an example of a configuration of a communication controller in the present disclosure. The communication controller 17 includes a first reception unit 171, a direction detection unit 172, an output unit 175, a second reception unit 176, a reception circuit 177, and a communication unit 178. FIG. 13 illustrates an example of the configuration of the communication controller in the present disclosure, and does not limit the configuration of the communication controller. In the present example embodiment, processing such as direction detection of the incoming direction of the spatial optical signal based on the optical signal received by the direction detection light receiving element PD1 and decoding of the communication signal based on the optical signal received by the communication light receiving element PD2 are executed by the communication controller 17. Processing such as direction detection of the incoming direction of the spatial optical signal based on the optical signal received by the direction detection light receiving element PD1 and decoding of the communication signal based on the optical signal received by the communication light receiving element PD2 may be executed by the detection circuit.

The first reception unit 171 is connected to the detection circuit 129. The first reception unit 171 receives a signal from the detection circuit 129. The signal received by the first reception unit 171 is derived from the optical signals received by the plurality of direction detection light receiving elements PD1. The first reception unit 171 outputs the received signal to the direction detection unit 172.

The direction detection unit 172 acquires a signal derived from each of the plurality of direction detection light receiving elements PD1. The direction detection unit 172 detects the incoming direction of the spatial optical signal according to the light receiving situation of the optical signal by each of the plurality of direction detection light receiving elements PD1. The direction detection unit 172 outputs detection information including the incoming direction of the spatial optical signal to the output unit 175.

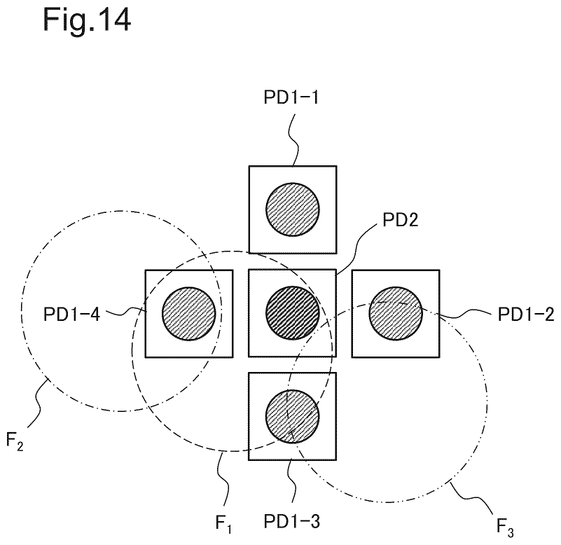

FIG. 14 is a conceptual diagram for describing detection of an incoming direction of a spatial optical signal by a direction detection unit in the present disclosure. FIG. 14 is a conceptual diagram of the light receiving face of the light receiver 12 when viewed from the ball lens 11. FIG. 14 illustrates a positional relationship between the direction detection light receiving element PD1 and the communication light receiving element PD2. In FIG. 14, a number (1 to 4) is added to the end of the plurality of direction detection light receiving elements PD1 to distinguish them from each other. The plurality of direction detection light receiving elements PD1-1 to 4 is disposed on the concentric circle centered on the communication light receiving element PD2. In FIG. 14, an example of an irradiation range of light condensed by the ball lens 11 is indicated by a circle.

The signal light with which the irradiation range F₁ (broken line) is irradiated is received by the direction detection light receiving element PD1-3 and the direction detection light receiving element PD1-4. The direction detection unit 172 determines the moving direction of the light receiver 12 according to the light receiving situation of the signal light by the direction detection light receiving element PD1-3 and the direction detection light receiving element PD1-4. When the irradiation range F₁ (broken line) is irradiated with the signal light is emitted within, the direction detection unit 172 outputs, to the output unit 175, information instructing to move the position of the light receiver 12 to the lower left. The direction detection unit 172 may be configured to determine the movement amount of the light receiver 12 according to the intensity of the signal light received by the direction detection light receiving element PD1-3 and the direction detection light receiving element PD1-4. The signal light with which the irradiation range F₁ (broken line)) is irradiated is received by the communication light receiving element PD2. The direction detection unit 172 may be configured to determine the moving direction and the moving amount of the light receiver 12 including the light receiving situation of the signal light by the communication light receiving element PD2.

The signal light with which the irradiation range F₂ (one-dot chain line)) is irradiated is received by the direction detection light receiving element PD1-4. The direction detection unit 172 determines the moving direction of the receiver 10 according to the light receiving situation of the signal light by the direction detection light receiving element PD1-4. When the irradiation range F₂ (one-dot chain line) is irradiated with the signal light, the direction detection unit 172 outputs, to the output unit 175, information instructing to move the position of the light receiver 12 leftward. The direction detection unit 172 may be configured to determine the movement amount of the light receiver 12 according to the intensity of the signal light received by the direction detection light receiving element PD1-4.

The signal light with which the irradiation range F₃ (two-dot chain line)) is irradiated is received by the direction detection light receiving element PD1-2 and the direction detection light receiving element PD1-3. The direction detection unit 172 determines the moving direction of the receiver 10 according to the light receiving situation of the signal light by the direction detection light receiving element PD1-2 and the direction detection light receiving element PD1-3. When the range of the irradiation range F₃ (two-dot chain line) is irradiated with the signal light, the direction detection unit 172 outputs, to the output unit 175, information instructing to move the position of the light receiver 12 to the lower right. The direction detection unit 172 may be configured to determine the movement amount of the receiver 10 according to the intensity of the signal light received by the direction detection light receiving element PD1-2 and the direction detection light receiving element PD1-3.

The output unit 175 is connected to the direction detection unit 172. The output unit 175 acquires detection information including the incoming direction of the spatial optical signal from the direction detection unit 172. For example, the detection information includes information instructing a direction in which the light receiver 12 is moved. Output unit 175 outputs the acquired detection information. For example, the output unit 175 outputs detection information to a terminal device (not illustrated) used by an administrator who manages the receiver 10. The information output to the terminal device is referred to as reference information for moving the direction of the light receiver 12.

The second reception unit 176 is connected to the communication light receiving element PD2. The second reception unit 176 receives a signal from the detection circuit 129. The signal received by the second reception unit 176 is derived from the optical signal received by the communication light receiving element PD2. The second reception unit 176 outputs the received signal to the reception circuit 177. As in the example of FIG. 12, when the detection circuit 129-3 amplifies/AD-converts the signal received by the communication light receiving element PD2, the second reception unit 176 acquires the converted signal from the detection circuit 129-3. In this case, the reception circuit 177 is omitted.

The reception circuit 177 acquires a signal derived from the optical signal received by the communication light receiving element PD2. The reception circuit 177 amplifies the acquired signal. The reception circuit 177 converts the amplified signal from an analog signal to a digital signal. The reception circuit 177 outputs the converted digital signal to the communication unit 178. When the signal derived from the optical signal received by the communication light receiving element PD2 is used for direction detection, the reception circuit 177 may be configured to output the converted signal to the direction detection unit 172. When the signal derived from the optical signal received by the communication light receiving element PD2 is used for the direction detection, the accuracy of the direction detection can be further improved.

For example, the reception circuit 177 may be provided with a limiting amplifier (not illustrated). In this case, the limiting amplifier is provided before the amplifier. When the limiting amplifier is provided, a dynamic range can be secured. For example, the reception circuit 177 may be provided with a filter (not illustrated) such as a high-pass filter or a band pass filter. For example, the filter cuts a signal derived from ambient light such as sunlight and selectively passes a signal of a high frequency component corresponding to the wavelength band of the spatial optical signal. When the filter is provided, an unnecessary wavelength component included in the spatial optical signal can be removed.

The communication unit 178 acquires the signal output from the reception circuit 177. The communication unit 178 decodes the acquired signal. The communication unit 178 generates communication information including the decoded information. For example, the communication information output by the output unit 175 is transmitted to an adjacent communication target. The communication information output by the output unit 175 may be provided to the outside via a network such as the Internet. For example, the output unit 175 may be configured to output information to a terminal device (not illustrated) used by an administrator who manages the receiver 10.

### [Display Example]

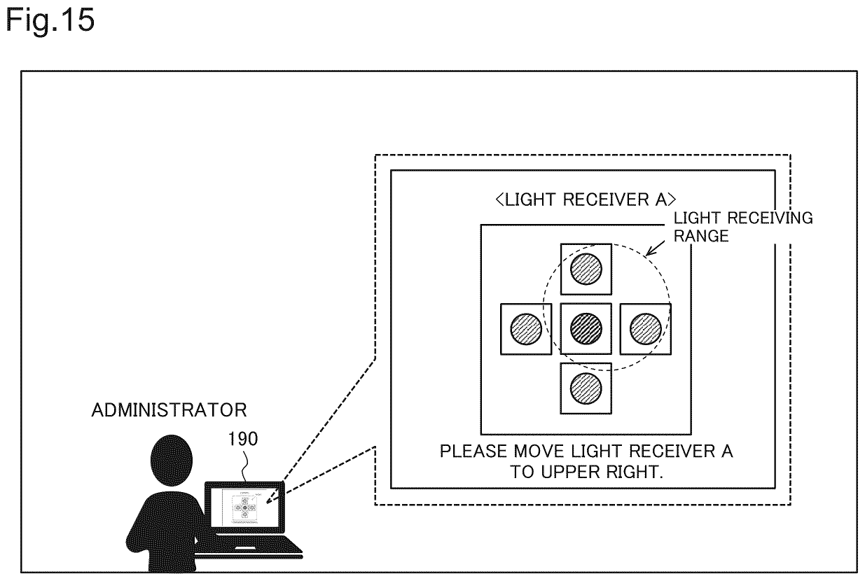

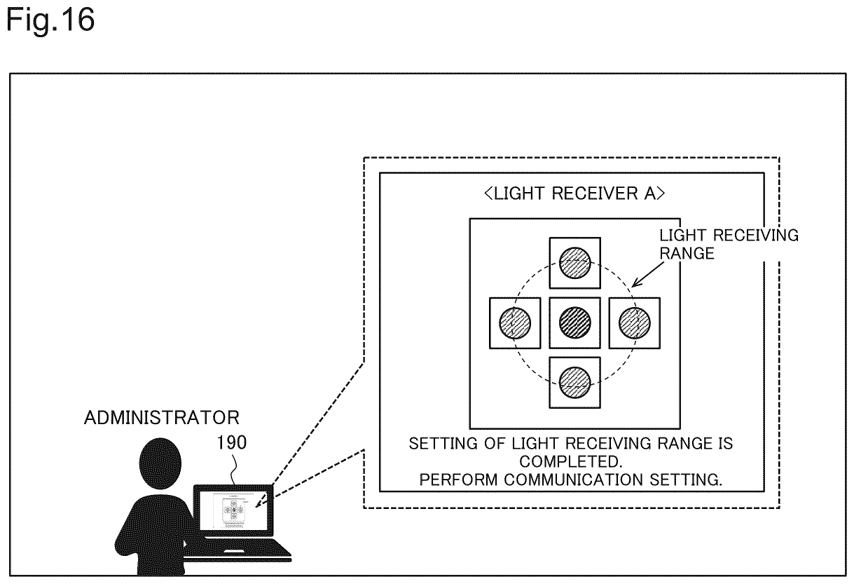

FIGS. 15 to 16 are conceptual diagrams illustrating display examples of detection information indicating a light receiving range of a spatial optical signal by a receiver in the present disclosure. FIGS. 15 to 16 illustrate examples in which the light receiving range of the spatial optical signal is displayed on the screen of a terminal device 190 used by the administrator. FIGS. 15 to 16 illustrate an example assuming a use case in which the light receiving direction of the spatial optical signal is manually changed. The light receiving direction of the spatial optical signal may be adjusted by a remote operation, an automatic adjustment function, or the like without human intervention.

FIG. 15 illustrates an example in which the light receiving range of the spatial optical signal is shifted from an appropriate position. An appropriate position of the light receiving range of the spatial optical signal is a position where a circle centered on the communication light receiving element and a circle indicating the light receiving range of the spatial optical signal coincide with each other. On the screen of the terminal device 190 used by the administrator, the light receiving range related to the spatial optical signal of one (light receiver A) of the plurality of light receivers 12 is displayed in association with the images of the direction detection light receiving element and the communication light receiving element. In the example of FIG. 15, the light receiving range is located at the upper right of the appropriate position. In order to move the light receiving range toward the communication light receiving element, the position of the light receiver 12 may be moved to the upper right. Therefore, in the example of FIG. 15, information including an instruction “Please move the light receiver A to the upper right” is displayed at the lower portion of the screen of the terminal device 190. By browsing the screen of the terminal device 190, the administrator can recognize that the light receiving range of the spatial optical signal approaches an appropriate position by moving the light receiver A to the upper right. For example, the administrator instructs the operator working at the site where the receiver 10 is disposed to move the light receiver A to the upper right, so that the light receiving range of the spatial optical signal by the light receiver A can be brought close to an appropriate position.

FIG. 16 illustrates an example in which the setting of the reception direction of the spatial optical signal is completed. In the example of FIG. 16, the circle indicating the light receiving range coincides with the circle centered on the communication light receiving element. That is, in the case of the example of FIG. 16, the setting of the light receiving range is completed. Therefore, in the example of FIG. 16, information including an instruction that “Setting of the light receiving range is completed. Perform communication setting” is displayed at the lower portion of the screen of the terminal device 190. By browsing the screen of the terminal device 190, the administrator can recognize that he or she can perform communication setting. For example, the administrator can proceed with work by instructing an operator working at a site where the receiver 10 is disposed to perform communication setting.

As described above, the light receiver according to the present example embodiment includes a ball lens, an annular track, and at least one movable light receiver. The annular track is disposed in such a way as to surround the lower portion of the ball lens. The movable light receiver is movably disposed along the outer periphery of the annular track. The movable light receiver includes a moving support base, a curved support column, and a light receiver. The moving support base is movably installed along the outer periphery of the annular track. The curved support column is curved in an arc shape along the circumference of a circle centered on the center point of the ball lens. The curved support column is erected on the upper portion of the moving support base. The curved support column movably supports the light receiver along a circumference of a circle centered on a center point of the ball lens. The light receiver is movably installed in a direction perpendicular to the annular track.

The light receiver includes a communication light receiving element, a plurality of direction detection light receiving elements, a wavelength filter, and an optical waveguide. The communication light receiving element is disposed with the light reception part facing the ball lens. The plurality of direction detection light receiving elements is annularly disposed around the communication light receiving element with the light reception part facing the ball lens. The wavelength filter is disposed between the ball lens and the communication light receiving element and between the ball lens and the plurality of direction detection light receiving elements. The wavelength filter allows light in a wavelength band of a spatial optical signal to be communicated to pass therethrough. The optical waveguide is disposed in association with each of the plurality of direction detection light receiving elements. The optical waveguide guides the optical signal condensed by the ball lens to the direction detection light receiving element.

The receiver of the present example embodiment can accurately detect the incoming direction of the spatial optical signal by the irradiation range of the optical signal detected by the plurality of direction detection light receiving elements. The receiver of the present example embodiment includes a movable light receiver movably disposed along the outer periphery of the annular track. The movable light receiver includes a light receiver movably installed in a direction perpendicular to the annular track. The position of the light receiver in the horizontal plane can be accurately adjusted by moving the light receiver along the outer periphery of the annular track. The position of the light receiver in the vertical plane can be accurately adjusted by moving the light receiver in a direction perpendicular to the annular track. That is, according to the present example embodiment, the position of the light receiver can be accurately adjusted in accordance with the incoming direction of the spatial optical signal.

In an aspect of the present example embodiment, the optical waveguide includes an optical fiber capable of transmitting light in a wavelength band of a spatial optical signal to be communicated. The incident end of the optical waveguide is connected to the wavelength filter. The emission end of the optical waveguide is connected to the light reception parts of the plurality of direction detection light receiving elements. According to this aspect, the optical waveguide including the optical fiber can guide the optical signal having passed through the wavelength filter to the direction detection light receiving element.

In an aspect of the present example embodiment, the communication light receiving element and the plurality of direction detection light receiving elements are disposed on the same face of the same substrate disposed in the condensing region of the ball lens. According to the present aspect, the communication light receiving element and the plurality of direction detection light receiving elements is disposed on the same substrate, so that the device size can be reduced.

A receiver according to an aspect of the present example embodiment includes a communication controller. The communication controller acquires an electric signal derived from optical signals received by the communication light receiving element and the plurality of direction detection light receiving elements included in the light receiver. The communication controller detects the incoming direction of the spatial optical signal according to the electric signal derived from the optical signals received by the plurality of direction detection light receiving elements. The communication controller outputs information about an incoming direction of the detected spatial optical signal. The communication controller decodes an electric signal derived from an optical signal received by the communication light receiving element. The communication controller outputs the decoded information. According to the present aspect, it is possible to provide information about the incoming direction of the spatial optical signal detected according to the optical signals received by the plurality of direction detection light receiving elements. For example, when the information about the incoming direction of the spatial optical signal is displayed on the screen of the terminal device, the position adjustment of the light receiver can be executed by referring to the information.

### Second Example Embodiment

Next, the light receiver according to a second example embodiment will be described with reference to the drawings. A light receiver of the present example embodiment is different from that of the first example embodiment in that light having passed through a wavelength filter is guided to a substrate on which a direction detection light receiving element is disposed using an optical waveguide of a direction detection light receiving element. The drawings used in the description of the present example embodiment are conceptual and do not accurately depict an actual structure. In the description of the present example embodiment, the description of portions similar to those of the first example embodiment will be simplified or omitted.

### (Configuration)

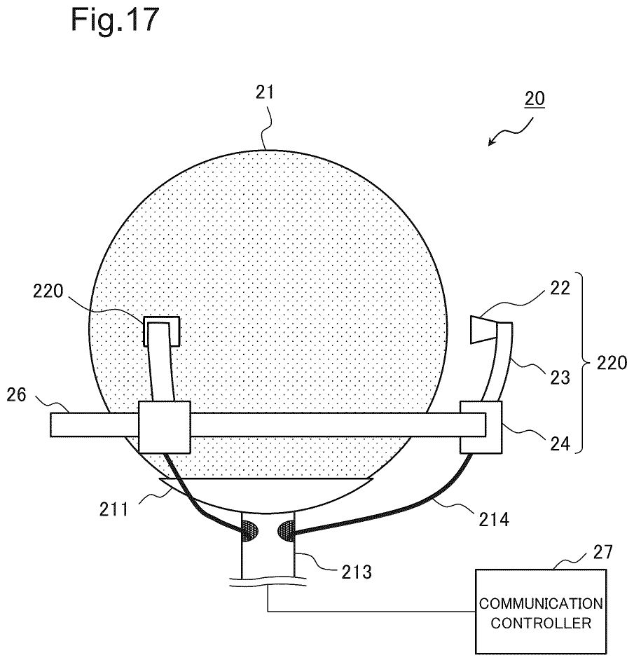

FIG. 17 is a conceptual diagram illustrating an example of a configuration of a receiver in the present disclosure. FIG. 17 is a conceptual diagram of the receiver when viewed from a side. A receiver 20 includes a ball lens 21, a light receiver 22, a curved support column 23, a moving support base 24, and an annular track 26. The receiver 20 may include a communication controller 27. The receiver 20 may include a support base 211 and a support column 213 that support the ball lens 21. Usually, the receiver 20 is housed inside a housing (not illustrated) in which a window for receiving a spatial optical signal is formed.

The light receiver 22, the curved support column 23, and the moving support base 24 constitute a movable light receiver 220. The receiver 20 includes at least one movable light receiver 220. The moving support base 24 is movable along the outer periphery of the annular track 26. The movable light receiver 220 moves along the circumferential direction of the ball lens 21 in accordance with the movement of the moving support base 24 along the outer periphery of the annular track 26. The light receiver 22 is movably installed on a horizontal plane along the circumferential direction of the ball lens 21 with the light receiving face facing the center point of the ball lens 21. In the present example embodiment, the movable light receiver 220 is configured to be manually movable.

The light receiver 22 has a configuration similar to that of the light receiver 12 in the first example embodiment. The light receiver 22 is connected to the communication controller 27. The light receiver 22 is connected to the communication controller 27 via wiring 214. The wiring 214 is connected to the communication controller 27 via the inside of the support column 213. The position where the communication controller 27 is disposed is not particularly limited. For example, the communication controller 27 is disposed in the vicinity of the receiver 20. For example, the communication controller 27 may be constructed as a microcomputer and built in the receiver 20. The communication controller 27 may be implemented in a cloud or a server connected to the receiver 20 via a network such as the Internet.

The ball lens 21 has a configuration similar to that of the ball lens 11 of the first example embodiment. The ball lens 21 is a spherical lens. The ball lens 21 is an optical element that collects a spatial optical signal coming from the outside. The ball lens 21 has a spherical shape when viewed from an any angle. The ball lens 21 is installed on the support base 211 supported by the support column 213. The annular track 26 is installed around the ball lens 21.

The ball lens 21 collects the incident spatial optical signal. Light (also referred to as a signal light) derived from the spatial optical signal condensed by the ball lens 21 is condensed toward the condensing region of the ball lens 21. Since the ball lens 21 has a spherical shape, the ball lens collects a spatial optical signal coming from an any direction. That is, the ball lens 21 exhibits similar light condensing performance for a spatial optical signal coming from an any direction. The light incident on the ball lens 21 is refracted when entering the ball lens 21. The light traveling inside the ball lens 21 is refracted again when being emitted to the outside of the ball lens 21. Most of the light emitted from the ball lens 21 is condensed toward the condensing region.

The light receiver 22 is vertically movably supported by the curved support column 23 along the circumferential direction of the ball lens 21. Part of the curved support column 23 is disposed inside the curved support column 23. On the upper side face of the curved support column 23, the light receiving face of the light receiver 22 is disposed toward the ball lens 21. Therefore, the light receiver 22 is vertically movably disposed in the condensing region including the condensing point of the ball lens 21. The light receiver 22 is supported by the curved support column 23 so that the light receiving face always faces the center point of the ball lens 21. The condensing point of the ball lens 21 is not uniquely determined. Therefore, the light receiver 22 is vertically movably disposed along the circumferential direction of the ball lens 21 in the condensing region including the condensing point of the ball lens 21. In the present example embodiment, the light receiver 22 is manually movably disposed.

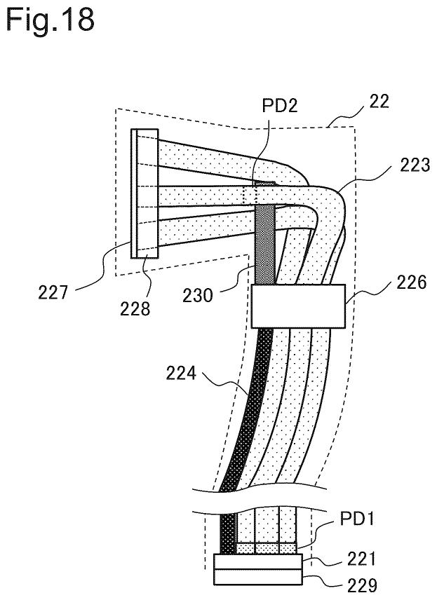

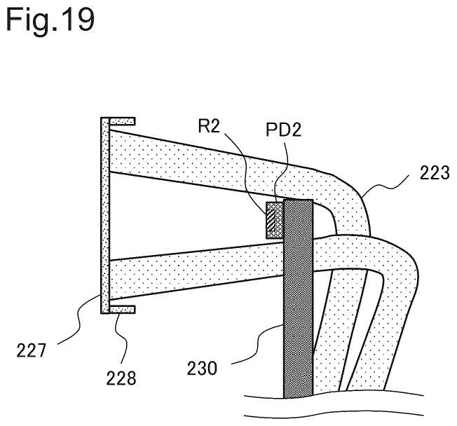

FIG. 18 and FIG. 19 are conceptual diagrams illustrating an example of a configuration of a light receiver in the present disclosure. FIG. 18 is a view of the light receiver when viewed from a side. FIG. 19 is a cross-sectional view illustrating a cross section of the light receiver taken along a cutting line passing through the communication light receiving element. In FIGS. 18 to 19, some components are not illustrated for convenience of description.

The light receiver 22 includes a plurality of direction detection light receiving elements PD1 and a communication light receiving element PD2. The light receiver 22 includes a substrate 221, a wavelength filter 227, a fixing ring 228, a detection circuit 229, and a rod-shaped substrate 230. Furthermore, the light receiver 22 includes an optical waveguide 223. In the example of FIGS. 18 to 19, the light receiver 22 includes four direction detection light receiving elements PD1. The four direction detection light receiving elements PD1 are disposed on the concentric circle centered on the communication light receiving element PD2. The number of the direction detection light receiving elements PD1 is not limited to four. The number of the direction detection light receiving elements PD1 may be equal to or more than five.

The direction detection light receiving element PD1 and the communication light receiving element PD2 are similar to those of the first example embodiment. The communication light receiving element PD2 is disposed in a condensing region of the ball lens 21. The light reception part R2 of the communication light receiving element PD2 is disposed toward the ball lens 21. The communication light receiving element PD2 receives the optical signal that has passed through the wavelength filter 227. On the other hand, the plurality of direction detection light receiving elements PD1 is disposed on the front face (the upper face in FIG. 18) of the substrate 221 disposed remotely from the condensing region of the ball lens 21. The plurality of direction detection light receiving elements PD1 receive the optical signal condensed by the ball lens 21 and passing through the wavelength filter 227 via the optical waveguide 223 extending from the wavelength filter 227 to the substrate 221. The plurality of direction detection light receiving elements PD1 and the communication light receiving element PD2 output electric signals related to the received optical signals to the detection circuit 229.

The plurality of direction detection light receiving elements PD1 is disposed on the front face (the upper face in FIG. 18) of the substrate 221. The positional relationship between the plurality of direction detection light receiving elements PD1 is not particularly limited. When viewed from the ball lens 21, the incident ends of the optical waveguides 223 connected to the plurality of direction detection light receiving elements PD1 are disposed on the concentric circle centered on the communication light receiving element PD2. The direction detection light receiving element PD1 has sensitivity to light in a wavelength band of a spatial optical signal to be communicated.

The output end of the optical waveguide 223 is connected to the light reception part R1 of the direction detection light receiving element PD1. The direction detection light receiving element PD1 receives an optical signal transmitted through the inside of the optical waveguide 223. The optical signal received by the direction detection light receiving element PD1 is converted into an electric signal. The converted electric signal is output to the detection circuit 229.

The communication light receiving element PD2 is disposed at the upper portion of the rod-shaped substrate 230. The light reception part R2 of the communication light receiving element PD2 is directed to the ball lens 21 via the wavelength filter 227. When viewed from the ball lens 21, the light reception part R2 of the communication light receiving element PD2 is disposed at the center point of the circle formed by the incident ends of the optical waveguides 223 connected to the plurality of direction detection light receiving elements PD1.

The light reception part R2 of the communication light receiving element PD2 is directed to the wavelength filter 227. The communication light receiving element PD2 receives the optical signal having passed through the wavelength filter 227. The optical signal received by the light reception part R2 of the communication light receiving element PD2 is converted into an electric signal. The converted electric signal is output to the detection circuit 229.

The substrate 221 is a printed circuit board. The plurality of direction detection light receiving elements PD1 is disposed on the front face (the upper face in FIG. 18) of the substrate 221. In the examples of FIGS. 18 to 19, four direction detection light receiving elements PD1 are disposed on the front face of the substrate 221. The detection circuit 229 is disposed on the back face (the lower face in FIG. 18) of the substrate 221. The detection circuit 229 may be disposed on the front face (the upper face in FIG. 18) of the substrate 221 or inside.

The optical waveguide 223 is configured in association with each of the plurality of direction detection light receiving elements PD1. A bundle of the plurality of optical waveguides 223 is collected by a fixture 226. The optical waveguide 223 is a transmission path that transmits light in a wavelength band of a spatial optical signal to be communicated. The incident end of the optical waveguide 223 is connected to a back face of the wavelength filter 227. The optical waveguide 223 is bent halfway and extends from the wavelength filter 227 to the substrate 221. The emission end of the optical waveguide 223 is connected to any of the light reception parts R1 of the plurality of direction detection light receiving elements PD1 disposed on the front face (the upper face in FIG. 18) of the substrate 221. The optical signal incident on the incident end of the optical waveguide 223 is transmitted through the inside of the optical waveguide 223 and is emitted from the emission end. The optical signal emitted from the emission end is received by the light reception part R1 of the direction detection light receiving element PD1 connected to the optical waveguide 223. For example, the optical waveguide 223 is achieved by an optical fiber made of glass or plastic having high transmittance with respect to light in a wavelength band of a spatial optical signal to be communicated. The optical waveguide 223 may include one optical fiber or a bundle of a plurality of optical fibers.

The wavelength filter 227 has a configuration similar to that of the wavelength filter 127 of the first example embodiment. The wavelength filter 227 is a wavelength filter through which light in a wavelength band of a spatial optical signal to be received passes. The wavelength filter 227 is fixed to the housing of the light receiver 22 by a fixing ring 228. The front face (the left face in FIG. 18) of the wavelength filter 227 is directed to the ball lens 21. The back face (the right face in FIG. 18) of the wavelength filter 227 is directed to the incident end of the optical waveguide 223 connected to the plurality of direction detection light receiving elements PD1 and the light receiving face of the communication light receiving element PD2. The incident end of the optical waveguide 223 is connected to a back face of the wavelength filter 227. The wavelength filter 227 passes light in a wavelength band of a spatial optical signal that is to be received by the direction detection light receiving element PD1 and the communication light receiving element PD2. In the portion connected to the optical waveguide 223, the optical signal that has passed through the wavelength filter 227 is received by any of the plurality of direction detection light receiving elements PD1 via the optical waveguide 223. The optical signal that has passed through the wavelength filter 227 in the front portion of the communication light receiving element PD2 is received by the communication light receiving element PD2. The wavelength filter 227 blocks light that is not a reception target. The main purpose of the wavelength filter 227 is to mitigate external light such as sunlight. In an environment less affected by sunlight or external light, the wavelength filter 227 may be omitted.

The fixing ring 228 has a configuration similar to that of the fixing ring 228 of the first example embodiment. The fixing ring 228 is a ring-shaped support member. The fixing ring 228 is a member for fixing the wavelength filter 227. The opening of the fixing ring 228 is formed larger than a circle surrounding the outer periphery of the incident end of the optical waveguide 223 connected to the plurality of direction detection light receiving elements PD1.

The detection circuit 229 is disposed on the back face (the lower face in FIG. 18) of the substrate 221. The detection circuit 229 may be disposed on the front face (the upper face in FIG. 18) of the substrate 221 or inside. The detection circuit 229 receives electric signals output from the direction detection light receiving element PD1 and the communication light receiving element PD2. The signal from the direction detection light receiving element PD1 is used to detect the incoming direction of the spatial optical signal. The signal from the communication light receiving element PD2 is used for communication with the communication target. The detection circuit 229 performs a signal process on the received electric signal. The detection circuit 229 outputs the electric signal subjected to the signal process to the communication controller 27. The electric signal output from the detection circuit 229 is transmitted to the communication controller 27 via the wiring 214.

The rod-shaped substrate 230 is a substrate that supports the communication light receiving element PD2. The rod-shaped substrate 230 is bundled together with a bundle of the plurality of optical waveguides 223 by the fixture 226. The communication light receiving element PD2 is disposed at the upper portion of the rod-shaped substrate 230. The position where the light reception part R2 of the communication light receiving element PD2 is disposed is directed toward the ball lens 21 via the wavelength filter 227. When viewed from the ball lens 21, the position where the communication light receiving element PD2 is disposed corresponds to the center point of the circle formed by the incident ends of the optical waveguides 223 connected to the plurality of direction detection light receiving elements PD1. The rod-shaped substrate 230 is connected to the communication controller 27 via wiring 224. An electric signal related to the optical signal received by the communication light receiving element PD2 is output to the communication controller 27 via the rod-shaped substrate 230.

The curved support column 23 is a hollow column supported by the moving support base 24. Part of the light receiver 22 is provided inside the curved support column 23. The curved support column 23 is curved in a shape along the circumference of the ball lens 21. That is, the curve of the curved support column 23 has an arc shape centered on the center point of the ball lens 21. A slit (not illustrated) opening in the longitudinal direction is formed on a side face of the curved support column 23, the side face facing the ball lens 21. The curved support column 23 movably supports the housing portion of the light receiver 22 along the circumferential direction of the ball lens 21 through the slit. The lower end of the curved support column 23 is fixed to the upper portion of the moving support base 24. In other words, the curved support column 23 is erected on the upper portion of the moving support base 24. The curved support column 23 moves along the circumferential direction of the ball lens 21 in accordance with the movement of the moving support base 24.

The moving support base 24 is movably installed at an outer peripheral portion of the annular track 26. The moving support base 24 grips an outer peripheral portion of the annular track 26. The moving support base 24 is movable along the circumferential direction of the annular track 26 in a state of gripping the outer edge portion of the annular track 26. A curved support column 23 is fixed to an upper portion of the moving support base 24. In other words, the curved support column 23 is erected on the upper portion of the moving support base 24. The inside of the moving support base 24 is hollow. The wiring 214 and the optical waveguide 223 connected to the light receiver 22 pass through the inside of the moving support base 24 and the support column 213 and extend to the communication controller 27.

As described above, the light receiver 22, the curved support column 23, and the moving support base 24 constitute the movable light receiver 220. The receiver 20 includes at least one movable light receiver 220. As the number of movable light receivers 220 increases, the number of communication targets capable of transmitting and receiving spatial optical signals increases. The number of movable light receivers 220 may be set according to the number of communication targets or a communication environment.

The annular track 26 is fixed to the ball lens 21 by a plurality of fixtures (not illustrated). The annular track 26 annularly surrounds the lower portion of the ball lens 21. The moving support base 24 is installed at an outer peripheral portion of the annular track 26. The moving support base 24 is movable along the circumferential direction of the annular track 26.

The communication controller 27 has a configuration similar to that of the communication controller 17 of the first example embodiment. The communication controller 27 acquires an electric signal derived from the optical signal received by the light receiver 22. The communication controller 27 detects the incoming direction of the spatial optical signal according to the electric signal derived from the optical signals received by the plurality of direction detection light receiving elements PD1. The communication controller 27 outputs information including the incoming direction of the detected spatial optical signal. The communication controller 27 decodes a signal derived from the optical signal received by the communication light receiving element PD2. For example, the communication controller 27 causes a transmitter (not illustrated) associated with the receiver 20 to transmit the spatial optical signal according to the content of the decoded signal.

For example, the information including the incoming direction of the spatial optical signal is displayed on a screen of a terminal device (not illustrated) used by an administrator who manages the receiver 20 or an operator who installs the receiver 20. For example, the operator who has confirmed the information related to the incoming direction of the spatial optical signal displayed on the terminal device moves the position of the light receiver 22. The operator moves the light receiver 22 to a position where the intensities of the optical signals received by the plurality of direction detection light receiving elements PD1 are uniform. For example, the operator moves the light receiver 22 in the direction in which the direction detection light receiving element PD1 in which the intensity of the optical signal is high is disposed. The operator moves the light receiver 22 to a position where the intensity of the optical signal received by the communication light receiving element PD2 is maximized, thereby establishing communication with the communication target.

### (Modifications)

Next, the light receiver of the modifications of the present example embodiment will be described with reference to the drawings. The light receiver of the present modification is different from that of the configuration of FIGS. 18 to 19 in that the plurality of direction detection light receiving elements PD1 and the communication light receiving element PD2 are disposed remotely from the condensing region of the ball lens.

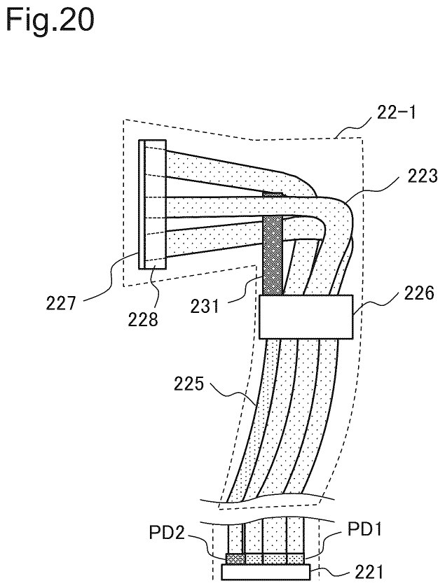

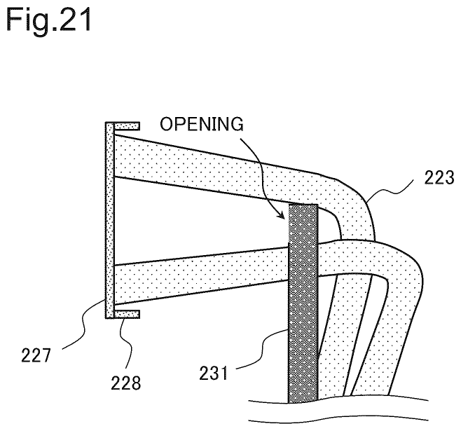

FIG. 20 and FIG. 21 are conceptual diagrams illustrating an example of a configuration of a light receiver in the present disclosure. FIG. 20 is a view of the light receiver when viewed from a side. FIG. 21 is a cross-sectional view illustrating a cross section of the light receiver taken along a cutting line passing through the communication light receiving element. In FIGS. 20 to 21, some components are not illustrated for convenience of description.

A light receiver 22-1 includes a plurality of direction detection light receiving elements PD1 and a communication light receiving element PD2. The light receiver 22-1 includes the substrate 221, the wavelength filter 227, the fixing ring 228, and the detection circuit 229. Further, the light receiver 22-1 includes a communication light guide 231, an optical waveguide 223, and a communication optical waveguide 225. The light receiver 22-1 is different from the light receiver 22 (FIGS. 18 to 19) in that a communication light guide 231 instead of the rod-shaped substrate 230 is included. Hereinafter, the description of the configuration similar to that of the light receiver 22 (FIGS. 18 to 19) will be omitted, and points different from the light receiver 22 will be described.

In the communication light guide 231, an opening associated with the condensing region of the ball lens 21 is formed. A light guide (to be described later) for guiding the light having passed through the wavelength filter 227 to the communication light receiving element is disposed inside the communication light guide 231. Part of the light guide as the communication optical waveguide 225 extends to the communication light receiving element PD2. An optical signal is incident on the incident end of the light guide through an opening of the communication light guide 231. The optical signal incident from the opening of the communication light guide 231 is guided to the communication light receiving element PD2 via the communication optical waveguide 225.

The communication optical waveguide 225 is a transmission path that transmits light in a wavelength band of a spatial optical signal to be communicated. The incident end of the communication optical waveguide 225 extends from a light guide included in the communication light guide 231. The communication optical waveguide 225 extends to the substrate 221. The emission end of the communication optical waveguide 225 is connected to the light reception part R2 of the communication light receiving element PD2 disposed on the front face (the upper face in FIG. 20) of the substrate 221. The optical signal incident on the communication optical waveguide 225 is transmitted through the inside of the communication optical waveguide 225 and is emitted from the emission end. The optical signal emitted from the emission end is received by the light reception part R2 of the communication light receiving element PD2 connected to the communication optical waveguide 225. For example, the communication optical waveguide 225 is achieved by an optical fiber made of glass or plastic having high transmittance with respect to light of a wavelength band of a spatial optical signal to be communicated. The communication optical waveguide 225 may include one optical fiber or a bundle of a plurality of optical fibers.

### [First Modification]

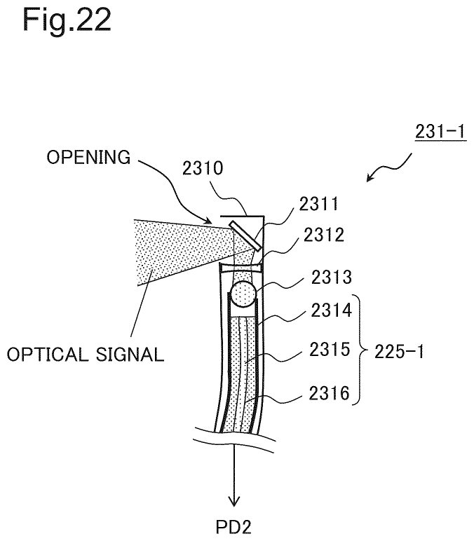

FIG. 22 is a conceptual diagram illustrating an example of a configuration of a communication light guide included in a light receiver according to a modification of the present disclosure. FIG. 22 illustrates a cross-sectional view including a main part of the communication light guide. A communication light guide 231-1 includes a housing 2310, a reflecting mirror 2311, a concave lens 2312, a ball lens 2313, a tubular member 2314, a core waveguide 2315, and a clad waveguide 2316.

The housing 2310 is a cylindrical hollow member. An opening is formed in part of a side face of the housing 2310. The opening formed in the side face of the housing 2310 is directed to the ball lens 21. The optical signal condensed by the ball lens 21 enters the housing 2310 through the opening.

The reflecting mirror 2311 is disposed with its reflection surface facing an opening formed on a side face of the housing 2310. The reflection surface of the reflecting mirror 2311 is directed downward at an angle of 45 degrees with respect to an opening surface of an opening formed on a side face of the housing 2310. The optical signal incident from the opening formed in the side face of the housing 2310 is reflected by the reflection surface of the reflecting mirror 2311 and travels along the longitudinal direction of the housing 2310.

The concave lens 2312 is disposed at a stage subsequent to the reflecting mirror 2311. The main plane of the concave lens 2312 is directed in a direction perpendicular to the longitudinal direction of the housing 2310. The optical signal reflected by the reflecting mirror 2311 is incident on the concave lens 2312. The concave lens 2312 converts the incident optical signal into parallel light.

The ball lens 2313 is a spherical lens. The ball lens 2313 has a spherical shape when viewed from an any angle. The ball lens 2313 is achieved by the same material as the ball lens 11 of the first example embodiment. The ball lens 2313 is fixed to an upper portion of the tubular member 2314. An annular track 16 is installed around the ball lens 11. The ball lens 2313 is irradiated with signal light converted into parallel light by the concave lens 2312. The incident end of the core waveguide 2315 is disposed in the condensing region of the ball lens 2313. The optical signal condensed by the ball lens 2313 enters the core waveguide 2315 from the incident end of the core waveguide 2315.

The tubular member 2314 is a tubular member. For example, the tubular member 2314 can be made of a material such as metal or plastic. The ball lens 2313 is disposed at the upper end of the tubular member 2314. The core waveguide 2315 and the clad waveguide 2316 are provided inside the tubular member 2314. The tubular member 2314 constitutes a communication optical waveguide 225-1 together with the core waveguide 2315 and the clad waveguide 2316. The communication optical waveguide 225-1 extends to the light reception part R2 of the communication light receiving element PD2. The communication optical waveguide 225-1 may include the core waveguide 2315 and the clad waveguide 2316.

The core waveguide 2315 is a transmission path that transmits light in a wavelength band of a spatial optical signal to be communicated. The core waveguide 2315 is configured to function as a core of an optical fiber. For example, the core waveguide 2315 is achieved by an optical fiber made of glass or plastic having high transmittance with respect to light in a wavelength band of a spatial optical signal to be communicated. The side face of the core waveguide 2315 is covered with the clad waveguide 2316. The refractive index of the core waveguide 2315 is larger than the refractive index of the clad waveguide 2316. The incident end of the core waveguide 2315 is disposed in the condensing region of the ball lens 2313. The incident end of the core waveguide 2315 is irradiated with the optical signal condensed by the ball lens 2313. The optical signal with which the incident end of the core waveguide 2315 is irradiated enters the core waveguide 2315 from the incident end. The optical signal having entered the core waveguide 2315 is transmitted toward the emission end while being totally reflected at the boundary surface with the clad waveguide 2316.

The clad waveguide 2316 is configured to function as a clad of an optical fiber. For example, the clad waveguide 2316 is achieved by glass or plastic having a refractive index smaller than that of the core waveguide 2315. The clad waveguide 2316 covers the side face of the core waveguide 2315. The refractive index of the clad waveguide 2316 is smaller than the refractive index of the core waveguide 2315. The optical signal having entered the core waveguide 2315 is transmitted toward the emission end of the core waveguide 2315 while being totally reflected at the boundary surface with the clad waveguide 2316.

### [Second Modification]

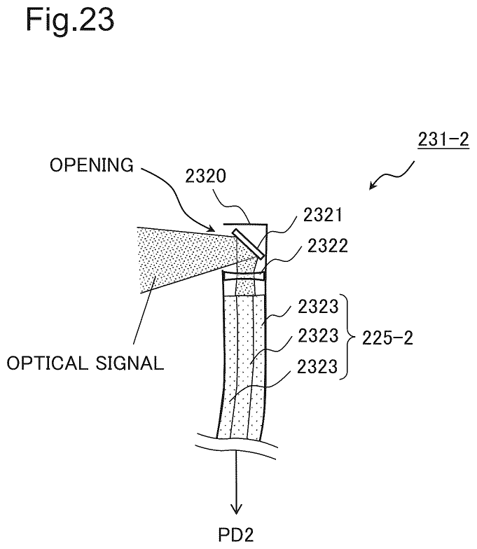

FIG. 23 is a conceptual diagram illustrating an example of a configuration of a communication light guide included in a light receiver according to a modification of the present disclosure. FIG. 23 illustrates a cross-sectional view including a main part of the communication light guide. A communication light guide 231-2 includes a housing 2320, a reflecting mirror 2321, a concave lens 2322, and a plurality of optical waveguides 2323.

The housing 2320 is a cylindrical hollow member. An opening is formed in part of a side face of the housing 2320. The opening formed in the side face of the housing 2320 is directed to the ball lens 21. The optical signal condensed by the ball lens 21 enters the housing 2320 through the opening.

The reflecting mirror 2321 is disposed with its reflection surface facing an opening formed on a side face of the housing 2320. The reflection surface of the reflecting mirror 2321 is directed downward at an angle of 45 degrees with respect to an opening surface of an opening formed on a side face of the housing 2320. The optical signal incident from the opening formed in the side face of the housing 2320 is reflected by the reflection surface of the reflecting mirror 2321 and travels along the longitudinal direction of the housing 2320.

The concave lens 2322 is disposed at a stage subsequent to the reflecting mirror 2321. The main plane of the concave lens 2322 is directed in a direction perpendicular to the longitudinal direction of the housing 2320. The optical signal reflected by the reflecting mirror 2321 is incident on the concave lens 2322. The concave lens 2322 converts the incident optical signal into parallel light.

The optical waveguide 2323 is a transmission path that transmits light in a wavelength band of a spatial optical signal to be communicated. The plurality of optical waveguides 2323 constitute a communication optical waveguide 225-2. For example, the optical waveguide 2323 is achieved by an optical fiber made of glass or plastic having high transmittance with respect to light in a wavelength band of a spatial optical signal to be communicated. The incident end of the optical waveguide 2323 is directed to the concave lens 2322.

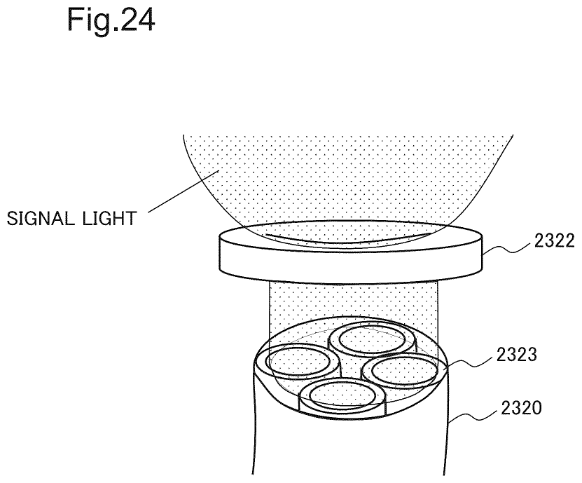

FIG. 24 is a conceptual diagram illustrating an example of a configuration of an optical waveguide included in a communication light guide included in a light receiver according to a modification of the present disclosure. FIG. 24 illustrates the incident end of the optical waveguide. The incident end of each of the plurality of optical waveguides 2323 is irradiated with an optical signal converted into parallel light by the concave lens 2322. The optical signal with which the incident end of the optical waveguide 2323 is irradiated enters the optical waveguide 2323 from the incident end. The optical signal that has entered the optical waveguide 2323 is transmitted toward the emission end.

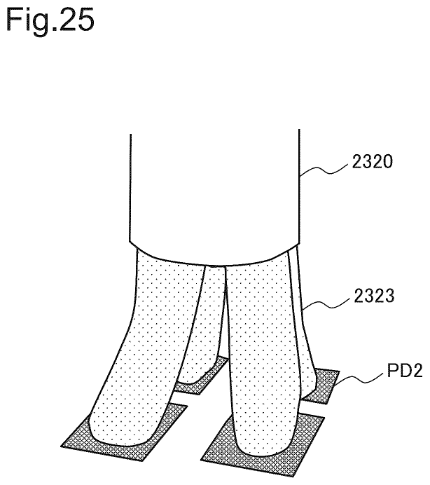

FIG. 25 is a conceptual diagram illustrating an example of a configuration of an optical waveguide included in a communication light guide included in a light receiver according to a modification of the present disclosure. FIG. 25 illustrates the emission end of the optical waveguide. The emission ends of the plurality of optical waveguides 2323 are connected to the light reception part R2 of the communication light receiving element PD2. In the example of FIG. 25, an example in which there is a plurality of communication light receiving elements PD2 is illustrated. The emission ends of the plurality of optical waveguides 2323 may be connected to the light reception part R2 of the single communication light receiving element PD2. The optical signal transmitted to the emission end of the optical waveguide 2323 is emitted toward the light reception part R2 of the communication light receiving element PD2.

### [Third Modification]

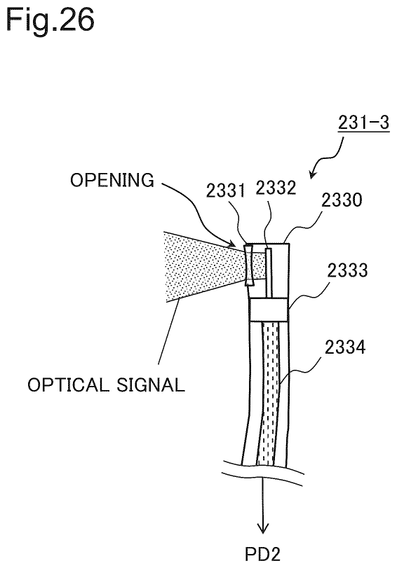

FIG. 26 is a conceptual diagram illustrating an example of a configuration of a communication light guide included in a light receiver according to a modification of the present disclosure. FIG. 26 illustrates a cross-sectional view including a main part of the communication light guide. A communication light guide 231-3 includes a housing 2330, a concave lens 2331, a grating element 2332, a connector 2333, and an optical waveguide 2334.

The housing 2330 is a cylindrical hollow member. An opening is formed in part of a side face of the housing 2330. The opening formed in the side face of the housing 2330 is directed to the ball lens 21. The concave lens 2331 is disposed in an opening formed in a side face of housing 2330. The optical signal condensed by the ball lens 21 enters the housing 2330 via the concave lens 2331 disposed in the opening.

The concave lens 2331 is disposed in an opening formed in a side face of housing 2330. The main plane of the concave lens 2331 is directed to the ball lens 21. The optical signal condensed by the ball lens 21 is incident on the concave lens 2331. The concave lens 2331 converts the incident optical signal into parallel light.

The grating element 2332 is an element in which a plurality of grating couplers is disposed on a light receiving face of a silicon photonics substrate. The light receiving face of the grating element 2332 is directed to the concave lens 2331. The light receiving face of the grating element 2332 is irradiated with the optical signal having passed through the concave lens 2331. The grating element 2332 receives an optical signal with which the light receiving face is irradiated by a plurality of grating couplers disposed on the front face. The optical signal received by the grating element 2332 is transmitted toward the optical waveguide 2334 via the connector 2333.

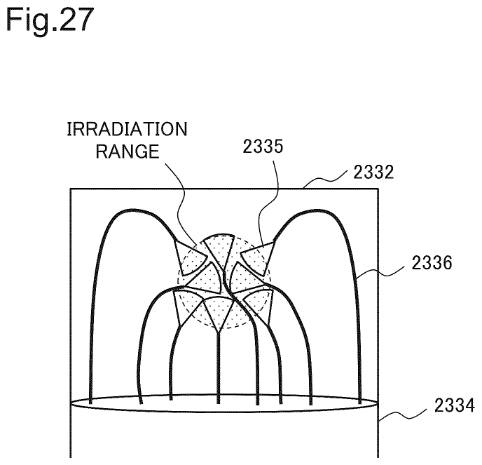

FIG. 27 is a conceptual diagram illustrating an example of a configuration of a grating element included in a communication light guide included in a light receiver according to a modification of the present disclosure. A plurality of grating couplers 2335 is disposed on the light receiving face of the grating element 2332. The plurality of grating couplers 2335 is disposed in an irradiation range of an optical signal. A light guide path 2336 is connected to each of the plurality of grating couplers 2335. The light guide path 2336 connected to each of the plurality of grating couplers 2335 is connected to the optical waveguide 2334. The plurality of aggregated light guide paths 2336 may constitute the optical waveguide 2334.

The optical waveguide 2334 is a transmission path that transmits light in a wavelength band of a spatial optical signal to be communicated. For example, the optical waveguide 2334 is achieved by an optical fiber made of glass or plastic having high transmittance with respect to light in a wavelength band of a spatial optical signal to be communicated. The incident end of the optical waveguide 2334 is connected to the plurality of light guide paths 2336. An optical signal received by each of the plurality of grating couplers 2335 is incident on the incident end of the optical waveguide 2334 via the plurality of light guide paths 2336. The optical signal incident from the incident end of the optical waveguide 2334 enters the optical waveguide 2334. The optical signal that has entered the optical waveguide 2334 is transmitted toward the emission end. The optical signal transmitted to the emission end of the optical waveguide 2334 is emitted toward the light reception part R2 of the communication light receiving element PD2.

As described above, the light receiver according to the present example embodiment includes a ball lens, an annular track, and at least one movable light receiver. The annular track is disposed in such a way as to surround the lower portion of the ball lens. The movable light receiver is movably disposed along the outer periphery of the annular track. The movable light receiver includes a moving support base, a curved support column, and a light receiver. The moving support base is movably installed along the outer periphery of the annular track. The curved support column is curved in an arc shape along the circumference of a circle centered on the center point of the ball lens. The curved support column is erected on the upper portion of the moving support base. The curved support column movably supports the light receiver along a circumference of a circle centered on a center point of the ball lens. The light receiver is movably installed in a direction perpendicular to the annular track.

The light receiver includes a communication light receiving element, a plurality of direction detection light receiving elements, a wavelength filter, and an optical waveguide. The communication light receiving element is disposed with the light reception part facing the ball lens. The plurality of direction detection light receiving elements is disposed on the substrate disposed at a position away from the condensing region of the ball lens. The wavelength filter is disposed between the ball lens and the communication light receiving element and between the ball lens and the plurality of direction detection light receiving elements. The wavelength filter allows light in a wavelength band of a spatial optical signal to be communicated to pass therethrough. The optical waveguide is disposed between each of the plurality of direction detection light receiving elements and the wavelength filter. The optical waveguide extends to the substrate on which the plurality of direction detection light receiving elements is disposed. The optical waveguide guides the optical signal having passed through the wavelength filter to each of the plurality of direction detection light receiving elements.

In the present example embodiment, the plurality of direction detection light receiving elements is disposed on the substrate disposed at a position away from the condensing region of the ball lens. The optical waveguide extends to the substrate on which the plurality of direction detection light receiving elements is disposed. According to the present aspect, by disposing the substrate on which the plurality of direction detection light receiving elements is disposed at a position away from the condensing region of the ball lens, the light receiver can be made compact.

In an aspect of the present example embodiment, the communication light receiving element is disposed on the substrate disposed in the condensing region of the ball lens. According to the present aspect, the configuration of the light receiver can be diversified by configuring the communication light receiving element and the plurality of direction detection light receiving elements on separate substrates.

A light receiver according to an aspect of the present example embodiment includes a movable light receiver and a communication light guide. The communication light guide device is disposed in the condensing region of the ball lens. The communication light guide device guides the optical signal condensed by the ball lens. The communication optical waveguide connects the light reception part of the communication light receiving element and the communication light guide. The communication optical waveguide guides the optical signal guided by the communication light guide to the communication light receiving element. The communication light receiving element and the plurality of direction detection light receiving elements is disposed at a position away from the condensing region of the ball lens. The optical waveguide and the communication optical waveguide extend to a substrate on which the communication light receiving element and the plurality of direction detection light receiving elements is disposed. According to the present aspect, the substrate on which the communication light receiving element and the plurality of direction detection light receiving elements are disposed is disposed at a position away from the condensing region of the ball lens, so that the light receiver can be made more compact.

### Third Example Embodiment

Next, the light receiver according to a third example embodiment will be described with reference to the drawings. The light receiver of the present example embodiment is different from the first to second example embodiments in that the movable light receiver automatically moves according to the control of the communication controller. Hereinafter, an example in which the movable light receiver included in the light receiver in the first example embodiment is configured to automatically move will be described. The configuration of the present example embodiment can also be applied to the light receiver in the second example embodiment. The drawings used in the description of the present example embodiment are conceptual and do not accurately depict an actual structure. In the description of the present example embodiment, the description of portions similar to those of the first to second example embodiments will be simplified or omitted.

### (Configuration)

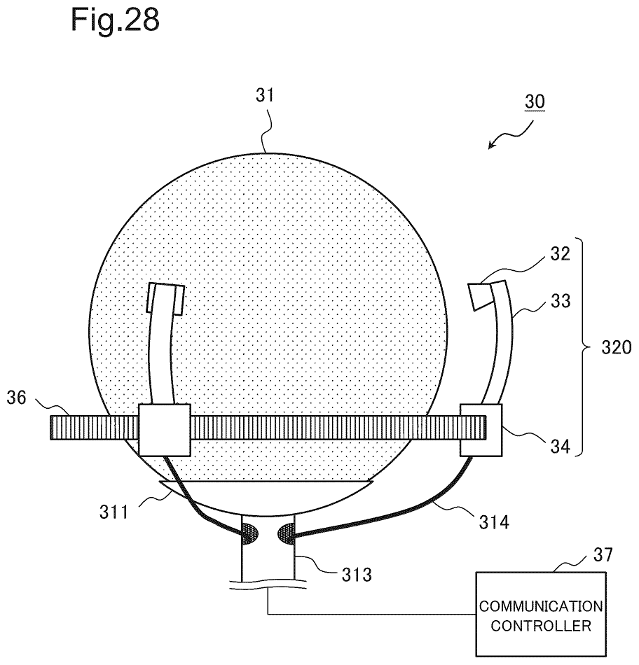

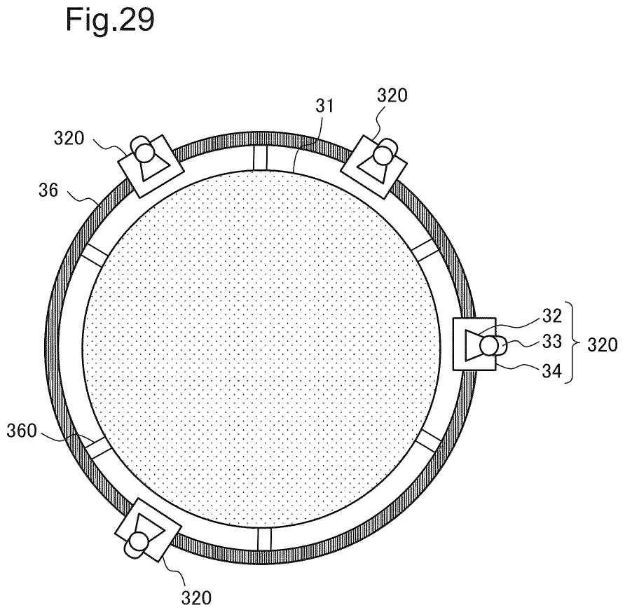

FIG. 28 and FIG. 29 are conceptual diagrams illustrating an example of a configuration of a receiver in the present disclosure. FIG. 28 is a conceptual diagram of the receiver when viewed from a side. FIG. 29 is a conceptual diagram of the receiver when viewed from above. A receiver 30 includes a ball lens 31, a light receiver 32, a curved support column 33, a moving support base 34 and an annular track 36. The receiver 30 may include a communication controller 37. The receiver 30 may include a support base 311 and a support column 313 that support the ball lens 31. Usually, the receiver 30 is housed inside a housing (not illustrated) in which a window for receiving a spatial optical signal is formed.

The light receiver 32, the curved support column 33, and the moving support base 34 constitute a movable light receiver 320. The receiver 30 includes at least one movable light receiver 320. The moving support base 34 is movable along the outer periphery of the annular track 36. The movable light receiver 320 moves along the circumferential direction of the ball lens 31 in accordance with the movement of the moving support base 34 along the outer periphery of the annular track 36. The light receiver 32 is movably installed on a horizontal plane along the circumferential direction of the ball lens 31 with the light receiving face facing the center point of the ball lens 31. In the present example embodiment, the movable light receiver 320 is configured to be automatically movable according to the control of the communication controller 37.

The light receiver 32 has a configuration similar to that of the light receiver 12 in the first example embodiment. The receiver 30 is connected to the communication controller 37. The light receiver 32 is connected to the communication controller 37 via the wiring 214. The wiring 314 is connected to the communication controller 37 via the inside of the support column 313. The position where the communication controller 37 is disposed is not particularly limited. For example, the communication controller 37 is disposed in the vicinity of the receiver 30. For example, the communication controller 37 may be constructed as a microcomputer and built in the receiver 30. The communication controller 37 may be implemented in a cloud or a server connected to the receiver 30 via a network such as the Internet.

The ball lens 31 has a configuration similar to that of the ball lens 11 in the first example embodiment. The ball lens 31 is a spherical lens. The ball lens 31 is an optical element that collects a spatial optical signal coming from the outside. The ball lens 31 has a spherical shape when viewed from an any angle. The ball lens 31 is installed on the support base 311 supported by the support column 313. An annular track 36 is installed around the ball lens 31.

The ball lens 31 collects the incident spatial optical signal. Light (also referred to as a signal light) derived from the spatial optical signal condensed by the ball lens 31 is condensed toward the condensing region of the ball lens 31. Since the ball lens 31 has a spherical shape, the ball lens collects a spatial optical signal coming from an any direction. That is, the ball lens 31 exhibits similar light condensing performance for a spatial optical signal coming from an any direction. The light incident on the ball lens 31 is refracted when entering the ball lens 31. The light traveling inside the ball lens 31 is refracted again when being emitted to the outside of the ball lens 31. Most of the light emitted from the ball lens 31 is collected toward the condensing region.

The light receiver 32 is vertically movably supported by the curved support column 33 along the circumferential direction of the ball lens 31. Part of the curved support column 33 is disposed inside the curved support column 33. On the upper side face of the curved support column 33, the light receiving face of the light receiver 32 is disposed toward the ball lens 31. The light receiver 32 is vertically movably disposed in the condensing region including the condensing point of the ball lens 31. The light receiver 32 is supported by the curved support column 33 so that the light receiving face always faces the center point of the ball lens 31. The condensing point of the ball lens 31 is not uniquely determined. Therefore, the light receiver 32 is vertically movably disposed along the circumferential direction of the ball lens 31 in the condensing region including the condensing point of the ball lens 31. In the present example embodiment, the light receiver 32 is disposed to be automatically movable according to the control by the communication controller 37.

The curved support column 33 is a hollow column supported by the moving support base 34. The curved support column 33 is curved in a shape along the circumference of the ball lens 31. That is, the curve of the curved support column 33 has an arc shape centered on the center point of the ball lens 31. A slit (not illustrated) opening in the longitudinal direction is formed on a side face of the curved support column 33, the side face facing the ball lens 31. The curved support column 33 movably supports the housing portion of the light receiver 32 along the circumferential direction of the ball lens 31 through the slit. The lower end of the curved support column 33 is fixed to the upper portion of the moving support base 34. In other words, the curved support column 33 is erected on the upper portion of the moving support base 34. The curved support column 33 moves along the circumferential direction of the ball lens 31 in accordance with the movement of the moving support base 34.

The moving support base 34 is movably installed at an outer peripheral portion of the annular track 36. The moving support base 34 grips an outer peripheral portion of the annular track 36. The moving support base 34 is movable along the circumferential direction of the annular track 36 in a state of gripping the outer edge portion of the annular track 36. A curved support column 33 is fixed to an upper portion of the moving support base 34. In other words, the curved support column 33 is erected on the upper portion of the moving support base 34. The inside of the moving support base 34 is hollow. Wiring 314 and the optical waveguide (not illustrated) connected to the light receiver 32 pass through the inside of the moving support base 34 and the support column 313 and extend to the communication controller 37.

As described above, the light receiver 32, the curved support column 33, and the moving support base 34 constitute the movable light receiver 320. The receiver 30 includes at least one movable light receiver 320. As the number of movable light receivers 320 increases, the number of communication targets capable of transmitting and receiving spatial optical signals increases. The number of movable light receivers 320 may be set according to the number of communication targets or a communication environment.

The annular track 36 is fixed to the ball lens 31 by a plurality of fixtures 360. The annular track 36 annularly surrounds the lower portion of the ball lens 31. The moving support base 34 is installed at an outer peripheral portion of the annular track 36. A gear is formed on the outer periphery of the annular track 36. The moving support base 34 is movable along the circumferential direction of the annular track 36.

The communication controller 37 acquires an electric signal derived from the optical signal received by the light receiver 32. The communication controller 37 detects the incoming direction of the spatial optical signal according to the electric signal derived from the optical signals received by the plurality of direction detection light receiving elements. The communication controller 37 controls the moving support base 34 according to the incoming direction of the spatial optical signal to move the position of the light receiver 32. The communication controller 37 moves the light receiver 32 to a position where the intensities of the optical signals received by the plurality of direction detection light receiving elements are uniform. For example, the communication controller 37 moves the light receiver 32 in the direction in which the direction detection light receiving element in which the intensity of the optical signal is high is disposed. The communication controller 37 may be configured to establish communication with the communication target by moving the light receiver 32 to a position where the intensity of the optical signal received by the communication light receiving element is maximized.

The communication controller 37 decodes a signal derived from the optical signal received by the communication light receiving element. For example, the communication controller 37 causes a transmitter (not illustrated) associated with the receiver 30 to transmit the spatial optical signal according to the content of the decoded signal.

### [Horizontal Movement Mechanism]

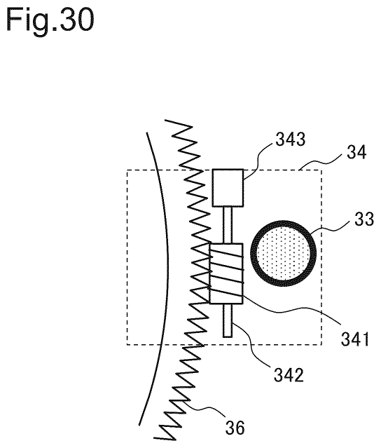

FIG. 30 is a conceptual diagram illustrating an example of a configuration of a horizontal movement mechanism included in a moving support base according to the present disclosure. The horizontal movement mechanism is a mechanism that moves the light receiver 32 on a horizontal plane. FIG. 30 is a view of a component for moving the movable light receiver when viewed from above. FIG. 30 illustrates components for moving the movable light receiver on a horizontal plane. The moving support base 34 includes a worm 341, a rotation shaft 342, and a stepping motor 343 as a horizontal movement mechanism.

The worm 341 is a cylindrical member. On the side face of the worm 341, helical teeth are formed in accordance with the number of teeth of the gear formed on the outer periphery of the annular track 36. The helical teeth formed on the side face of the worm 341 meshes with a gear formed on the outer periphery of the annular track 36. The worm 341 functions as a worm gear in combination with a gear formed on the outer periphery of the annular track 36. The rotation shaft 342 penetrates the central axis of the worm 341. The worm 341 rotates with the rotation of the rotation shaft 342. The moving support base 34 moves along the outer periphery of the annular track 36 as the worm 341 rotates. As the moving support base 34 moves along the outer periphery of the annular track 36, the light receiver 32 rotates in the horizontal direction in the condensing region of the ball lens 31.

The rotation shaft 342 is a rod-shaped member. The rotation shaft 342 penetrates the central axis of the worm 341. One end of the rotation shaft 342 is connected to the shaft of the stepping motor 343. The rotation shaft 342 may have a configuration in which the shaft of the stepping motor 343 extends. The rotation shaft 342 rotates in accordance with the rotation of the shaft of the stepping motor 343.

The stepping motor 343 is a motor that rotates by a certain angle in response to an input of an electric signal (control signal). The stepping motor 343 can control not only the number of rotations but also the rotation angle. For example, the stepping motor 343 is achieved by a small motor such as a micro stepping motor. The stepping motor 343 is fixed to a housing (not illustrated) of the moving support base 34. The shaft of the stepping motor 343 is connected to the rotation shaft 342. The shaft of the stepping motor 343 and the rotation shaft 342 may be formed of a common component. The stepping motor 343 is driven according to the control of the communication controller 37. When the stepping motor 343 is driven, the worm 341 rotates through the rotation shaft 342, and the movable light receiver 320 moves along the outer periphery of the annular track 36. Along with the movement of the movable light receiver 320, the light receiver 32 is moved to an appropriate light receiving position.

### [Vertical Movement Mechanism]

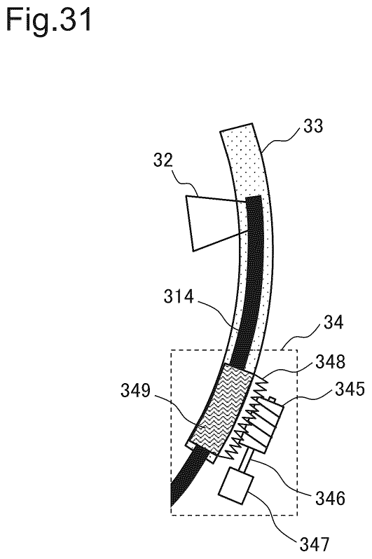

FIG. 31 is a conceptual diagram illustrating an example of a configuration of a vertical movement mechanism included in a moving support base according to the present disclosure. The vertical movement mechanism is a mechanism that moves the light receiver 32 in a vertical plane perpendicular to the track plane (horizontal plane) of the annular track 36. FIG. 31 is a view of a component for moving the movable light receiver when viewed from a side. FIG. 31 illustrates components for moving the movable light receiver in a vertical plane. FIG. 31 is a cross-sectional view of only a portion of the curved support column 13. The moving support base 34 includes a worm 345, a rotation shaft 346, and a stepping motor 347 as vertical movement mechanisms.

A fixture 349 is disposed inside the curved support column 33. The fixture 349 fixes the wiring 114 in such a way as to wrap the wiring 114. The fixture 349 is movable inside the curved support column 33. A slit (not illustrated) is formed in the curved support column 33 at a peripheral position where the fixture 349 is disposed. A gear member 348 curved along the outer periphery of the curved support column 33 is connected to the fixture 349. The fixture 349 is connected to the gear member 348 via a slit formed in the curved support column 33.

The worm 345 is a cylindrical member. On the side face of the worm 345, helical teeth are formed in accordance with the number of teeth of the gear member 348 connected to the fixture 349. The helical teeth formed on the side face of the worm 345 are meshed with the gear member 348. The gear member 348 is formed along the outer periphery of the curved support column 33. The gear member 348 forms an arc centered on the center point of the ball lens 31. The worm 345 functions as a worm gear in combination with the gear member 348. The rotation shaft 346 penetrates the central axis of the worm 345. The worm 345 rotates with the rotation of the rotation shaft 346. The light receiver 32 moves along the inner periphery of the curved support column 33 with the rotation of the worm 345. That is, the light receiver 32 moves along the inner periphery of the curved support column 33 to rotate and move in the vertical direction in the condensing region of the ball lens 31.

The rotation shaft 346 is a rod-shaped member. The rotation shaft 346 penetrates the central axis of the worm 345. One end of the rotation shaft 346 is connected to the shaft of the stepping motor 347. The rotation shaft 346 may have a configuration in which the shaft of the stepping motor 347 extends. The rotation shaft 346 rotates in accordance with the rotation of the shaft of the stepping motor 347.

The stepping motor 347 is a motor that rotates by a certain angle in response to an input of an electric signal (control signal). The stepping motor 347 can control not only the number of rotations but also the rotation angle. For example, the stepping motor 347 is achieved by a small motor such as a micro stepping motor. The stepping motor 347 is fixed to a housing (not illustrated) of the moving support base 34. The shaft of the stepping motor 347 is connected to the rotation shaft 346. The shaft of the stepping motor 347 and the rotation shaft 346 may be formed of a common component. The stepping motor 347 is driven according to the control of the communication controller 37. When the stepping motor 347 is driven, the worm 345 rotates through the rotation shaft 346, and the light receiver 32 rotationally moves along the inner periphery of the curved support column 33.

### [Communication Controller]

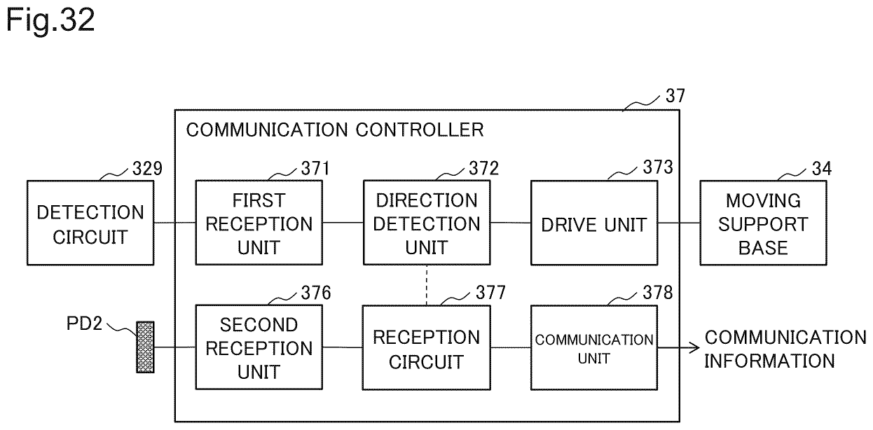

Next, a detailed configuration of the communication controller in the present example embodiment will be described with reference to the drawings. FIG. 32 is a block diagram illustrating an example of a configuration of a communication controller in the present disclosure. The communication controller 37 includes a first reception unit 371, a direction detection unit 372, a drive unit 373, a second reception unit 376, a reception circuit 377, and a communication unit 378. FIG. 32 illustrates an example of the configuration of the communication controller in the present disclosure, and does not limit the configuration of the communication controller. In the present example embodiment, processing such as direction detection of the incoming direction of the spatial optical signal based on the optical signal received by the direction detection light receiving element and the decoding of the communication signal based on the optical signal received by the communication light receiving element PD2 are executed by the communication controller 37. These processes may be configured to be executed by a detection circuit (not illustrated) included in the receiver 30.

The first reception unit 371 has a configuration similar to that of the first reception unit 171 in the first example embodiment. The first reception unit 371 is connected to a detection circuit 329. The detection circuit 329 has a configuration similar to the detection circuit 129 in the first example embodiment. The first reception unit 371 receives a signal from the detection circuit 329. The signal received by the first reception unit 371 is derived from the optical signals received by the plurality of direction detection light receiving elements. The first reception unit 371 outputs the received signal to the direction detection unit 372.

The direction detection unit 372 acquires a signal derived from each of the plurality of direction detection light receiving elements. The direction detection unit 372 detects the incoming direction of the spatial optical signal according to the light receiving situation of the optical signal by each of the plurality of direction detection light receiving elements. The direction detection unit 372 generates a control signal for setting the moving direction and the moving amount of the light receiver 32 according to the detected incoming direction of the spatial optical signal. For example, the direction detection unit 372 sets the moving direction and the moving amount of the light receiver 32 using the method of the first example embodiment (see FIG. 14). The direction detection unit 372 outputs the generated control signal to the drive unit 373.

The drive unit 373 acquires a control signal for setting the moving direction and the moving amount of the light receiver 32 from the direction detection unit 372. The drive unit 373 drives the vertical movement mechanism and the horizontal movement mechanism included in the moving support base 34 according to the acquired control signal. The drive unit 373 drives the vertical movement mechanism and the horizontal movement mechanism included in the moving support base 34 to move the light receiver 32 in the vertical plane and the horizontal plane.

The second reception unit 376 has a configuration similar to that of the second reception unit 176 in the first example embodiment. The second reception unit 376 is connected to the communication light receiving element PD2. The second reception unit 376 receives a signal from the detection circuit 329. The signal received by the second reception unit 376 is derived from the optical signal received by the communication light receiving element PD2. The second reception unit 376 outputs the received signal to the reception circuit 377. As in the example of FIG. 12, when the detection circuit 329 amplifies/AD-converts the signal received by the communication light receiving element PD2, the second reception unit 376 acquires the converted signal from the detection circuit 329. In this case, the reception circuit 377 is omitted.

The reception circuit 377 has a configuration similar to that of the reception circuit 177 in the first example embodiment. The reception circuit 377 acquires a signal derived from the optical signal received by the communication light receiving element PD2. The reception circuit 377 amplifies the acquired signal. The reception circuit 377 converts the amplified signal from an analog signal to a digital signal. The reception circuit 377 outputs the converted digital signal to the communication unit 378. When the signal derived from the optical signal received by the communication light receiving element PD2 is used for direction detection, the reception circuit 377 may be configured to output the converted signal to the direction detection unit 372. When the signal derived from the optical signal received by the communication light receiving element PD2 is used for the direction detection, the accuracy of the direction detection can be further improved.

The communication unit 378 has a configuration similar to that of the communication unit 178 in the first example embodiment. The communication unit 378 acquires the signal output from the reception circuit 377. The communication unit 378 decodes the acquired signal. The communication unit 378 generates communication information including the decoded information. For example, the communication information output by the communication unit 378 is transmitted to an adjacent communication target. The communication information output by the communication unit 378 may be provided to the outside via a network such as the Internet. For example, the communication unit 378 may be configured to output information to a terminal device (not illustrated) used by an administrator who manages the receiver 30.

As described above, the light receiver according to the present example embodiment includes a ball lens, an annular track, and at least one movable light receiver. The annular track is disposed in such a way as to surround the lower portion of the ball lens. The movable light receiver is movably disposed along the outer periphery of the annular track. The movable light receiver includes a moving support base, a curved support column, and a light receiver. The moving support base is movably installed along the outer periphery of the annular track. The moving support base includes a horizontal movement mechanism and a vertical movement mechanism. The horizontal movement mechanism moves the light receiver along the circumference of a circle centered on the center point of the ball lens in a horizontal plane along the outer periphery of the annular track. The vertical movement mechanism moves the light receiver along the circumference of a circle centered on the center point of the ball lens in a vertical plane perpendicular to the horizontal plane. The curved support column is curved in an arc shape along the circumference of a circle centered on the center point of the ball lens. The curved support column is erected on the upper portion of the moving support base. The curved support column movably supports the light receiver along a circumference of a circle centered on a center point of the ball lens. The light receiver is movably installed in a direction perpendicular to the annular track.

The light receiver includes a communication light receiving element, a plurality of direction detection light receiving elements, a wavelength filter, and an optical waveguide. The communication light receiving element is disposed with the light reception part facing the ball lens. The plurality of direction detection light receiving elements is annularly disposed around the communication light receiving element with the light reception part facing the ball lens. The wavelength filter is disposed between the ball lens and the communication light receiving element and between the ball lens and the plurality of direction detection light receiving elements. The wavelength filter is disposed in association with each of the plurality of direction detection light receiving elements. The optical waveguide guides the optical signal condensed by the ball lens to the direction detection light receiving element.

The moving support base of the present example embodiment includes a horizontal movement mechanism and a vertical movement mechanism. The horizontal movement mechanism moves the light receiver along the circumference of a circle centered on the center point of the ball lens in a horizontal plane along the outer periphery of the annular track. The vertical movement mechanism moves the light receiver along the circumference of a circle centered on the center point of the ball lens in a vertical plane perpendicular to the horizontal plane. That is, according to the present example embodiment, by driving the horizontal movement mechanism and the vertical movement mechanism, the position of the light receiver can be accurately adjusted in accordance with the incoming direction of the spatial optical signal.

A receiver according to an aspect of the present example embodiment includes a communication controller. The communication controller acquires an electric signal derived from optical signals received by the communication light receiving element and the plurality of direction detection light receiving elements included in the light receiver. The communication controller detects the incoming direction of the spatial optical signal according to the electric signal derived from the optical signals received by the plurality of direction detection light receiving elements. The communication controller moves the horizontal movement mechanism and the vertical movement mechanism of the moving support base in such a way that the light receiving face of the light receiver is directed to the incoming direction of the detected spatial optical signal. The communication controller outputs information about an incoming direction of the detected spatial optical signal. The communication controller decodes an electric signal derived from an optical signal received by the communication light receiving element. The communication controller outputs the decoded information. According to the present aspect, by driving the horizontal movement mechanism and the vertical movement mechanism in such a way that the light receiving face of the light receiver is directed in the incoming direction of the spatial optical signal, the light receiving face of the light receiver can be accurately adjusted toward the incoming direction of the spatial optical signal.

### Fourth Example Embodiment

Next, a communication device according to a fourth example embodiment will be described with reference to the drawings. The communication device of the present example embodiment has a configuration in which a transmitter and a receiver are combined. The transmitter is not particularly limited as long as it can receive the spatial optical signal. The receiver is any of the first to fourth example embodiments. Hereinafter, an example of a receiver having a light receiving function including a ball lens will be described. The communication device of the present example embodiment may include a receiver having other light receiving functions instead of the light receiving function including the ball lens.

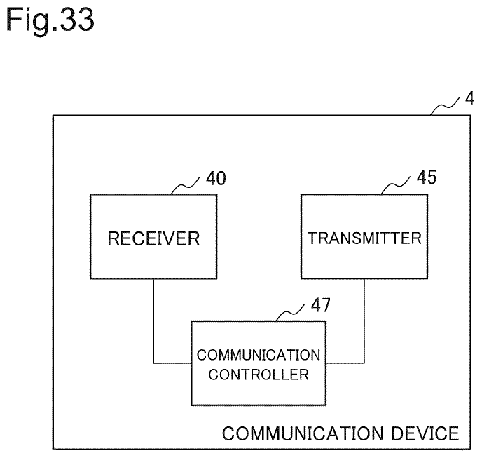

FIG. 33 is a block diagram illustrating an example of a configuration of a communication device in the present disclosure. A communication device 4 includes a receiver 40, a transmitter 45, and a communication controller 47. In the present example embodiment, an example in which spatial optical communication using a spatial optical signal with another communication device 4 as a communication target is performed will be described. In the present example embodiment, an example in which a phase modulation type spatial light modulator is included in a transmitter will be described.

The receiver 40 is any one of the receivers of the first to third example embodiments. The receiver 40 receives a spatial optical signal transmitted from a communication target (not illustrated). The receiver 40 converts the received spatial optical signal into an electric signal. The receiver 40 outputs the converted electric signal to the communication controller 47.

The transmitter 45 acquires a control signal from the communication controller 47. The transmitter 45 projects a spatial optical signal according to the control signal. The spatial optical signal projected from the transmitter 45 is received by a communication target (not illustrated) of a transmission destination of the spatial optical signal.

The communication controller 47 acquires a signal output from the receiver 40. The communication controller 47 performs a process according to the acquired signal. The communication controller 47 executes a direction detection process of a communication target and a communication process with the communication target. The communication controller 47 outputs a control signal for transmitting an optical signal related to the executed process to the transmitter 45. For example, the communication controller 47 performs a process based on a predetermined condition according to information included in the signal received by the receiver 40. For example, the communication controller 47 performs a process designated by an administrator of the communication device 4 according to information included in a signal received by the receiver 40.

### [Transmitter]

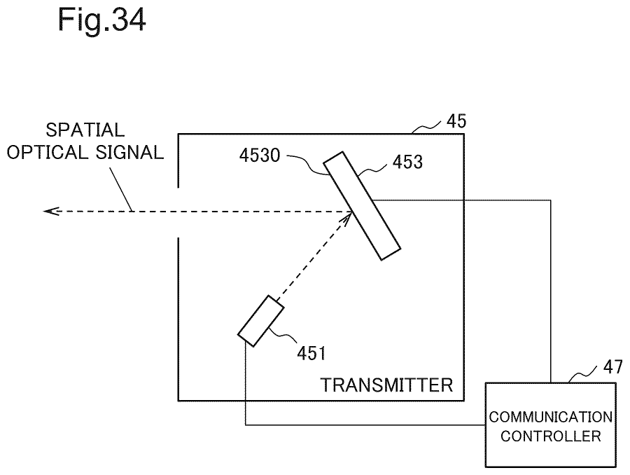

FIG. 34 is a conceptual diagram illustrating an example of a configuration of a transmitter in the present disclosure. FIG. 34 illustrates an example in which light in the Fraunhofer region is used. FIG. 34 illustrates a minimum configuration for transmitting the spatial optical signal. The transmitter 45 includes a light source 451 and a spatial light modulator 453.

The light source 451 is disposed inside the housing of the transmitter 45 with the emission face facing obliquely upward. The emission face of the light source 451 is directed to a modulation part 4530 of the spatial light modulator 453 disposed above. The light source 451 includes at least one emitter (not illustrated). The at least one emitter emits the emission light according to the control of the communication controller 47. The light source 451 includes a collimator (not illustrated). The emission light emitted from the emitter is converted into parallel light (illumination light) by the collimator and emitted from the light source 451.

For example, the light source 451 may include a plurality of emitters that emit the emission light in the same wavelength band. For example, the light source 451 is achieved by a laser array in which a plurality of emitters is disposed in an array. For example, the light source 451 may be a combination of a plurality of emitters that emit illumination light in the same wavelength band and an emitter that emits illumination light in a wavelength band different from that of the plurality of emitters. For example, the light source 451 may have a configuration in which an emitter that emits laser light in a wavelength band used for communication with a communication target and an emitter that emits laser light in a wavelength band different from the wavelength band of the laser light are combined.

For example, one of the plurality of emitters constituting the laser array is configured as a search emitter, and the other is configured as a communication emitter. For example, the search emitter emits light in a wavelength band of 850 nm, and the communication emitter emits light in a wavelength band of 1550 nm. When the laser array is configured as described above, search is performed using the search emitter (850 nm), and when the search is completed, communication can be switched to communication using the communication emitter (1550 nm). In this case, a silicon-based photodiode can be applied to the direction detection light receiving element PD1. On the other hand, a germanium-based photodiode can be applied to the direction detection light receiving element PD1. A wavelength filter that selectively allows light in a wavelength band of 850 nm to pass is disposed before the direction detection light receiving element PD1. A wavelength filter that selectively allows light in a wavelength band of 1550 nm to pass is disposed before the communication light receiving element PD2. As compared with the germanium-based photodiode, the silicon-based photodiode is less expensive and larger in size. Even when the direction detection light receiving element PD1 and the communication light receiving element PD2 have different wavelength filters, when a silicon-based photodiode can be applied to the direction detection light receiving element PD1, accuracy of direction detection is improved. The search emitter and the communication emitter may emit light in the same wavelength band. In this case, a single wavelength filter can be disposed before the direction detection light receiving element PD1 and the communication light receiving element PD2.

For example, an emitter included in the light source 451 emits laser light in a predetermined wavelength band. The wavelength of the laser light emitted from the emitter is not particularly limited, and may be selected according to the application. For example, the emitter emits the laser light in the visible or infrared wavelength band. For example, in the case of near infrared rays of 800 to 1000 nm, since the laser class can be increased as compared with that of visible light, the sensitivity can be improved as compared with that of visible light. For example, a laser light source having a higher output can be used for infrared rays in a wavelength band of 1.55 micrometers (μm) than near infrared rays of 800 to 1000 nm. As a laser light source that emits infrared rays in a wavelength band of 1.55 μm, an aluminum gallium arsenide phosphorus (AlGaAsP)—based laser light source, an indium gallium arsenide (InGaAs)-based laser light source, or the like can be used. The longer the wavelength of the laser light is, the larger the diffraction angle can be made and the higher the energy can be set. For example, the emitter may be achieved by a face light emitting element such as a photonic crystal surface emitting laser (PCSEL) type laser.

For example, a collimator is disposed on the emission face of the emitter. The collimator converts the emission light emitted from the emitter into the parallel light. The parallel light (illumination light) converted by the collimator is applied to the modulation part 4530 of the spatial light modulator 453. For example, each of the plurality of emitters is associated with at least any one of the plurality of modulation regions set in the modulation part 4530 of the spatial light modulator 453. The illumination light derived from the emission light emitted from each of the plurality of emitters travels toward the associated modulation region.

The spatial light modulator 453 is a phase modulation type spatial light modulator. The spatial light modulator 453 includes the modulation part 4530. The spatial light modulator 453 is disposed obliquely above the light source 451. The modulation part 4530 of the spatial light modulator 453 is directed to the emission face of the light source 451. In the example of FIG. 34, the spatial light modulator 453 is disposed inside the transmitter 45. The spatial light modulator 453 is disposed at a position where reflected light (modulated light) of the illumination light with which the modulation part 4530 is irradiated is transmitted as a spatial optical signal. The illumination light with which the modulation part 4530 of the spatial light modulator 453 is irradiated is modulated according to the pattern (phase image) set in the modulation part 4530. The modulated light modulated by the modulation part 4530 is transmitted as a spatial optical signal. The traveling direction of the spatial optical signal (modulated light) is adjusted according to the set pattern (phase image) of the modulation part 4530.

For example, the spatial light modulator 453 is achieved by a spatial light modulator using ferroelectric liquid crystal, homogeneous liquid crystal, vertical alignment liquid crystal, or the like. For example, the spatial light modulator 453 can be achieved by liquid crystal on silicon (LCOS). The spatial light modulator 453 may be achieved by a micro electro mechanical system (MEMS). In the phase modulation type spatial light modulator 453, energy can be concentrated on a portion of an image by operating to sequentially switch portions used for transmission of the spatial optical signal T. Therefore, in the case of using the phase modulation type spatial light modulator 453, when the outputs of the emitters included in the light source 451 are the same, the image can be displayed brighter than other methods.

At least one modulation region is set in the modulation part 4530 of the spatial light modulator 453. The number of modulation regions set in the modulation part 4530 is set in accordance with the number of emitters included in the light source 451. Each of the plurality of modulation regions is associated with any of the plurality of emitters included in the light source 451. Each of the plurality of modulation regions is irradiated with illumination light derived from the laser light emitted from the associated emitter. However, the relevant relationship between the modulation region and the emitter is not particularly limited as long as the illumination light derived from the laser light emitted from the emitter is incident on the modulation face of the modulation region. The number of modulation regions set in the modulation part 4530 may be different from the number of emitters included in the light source 451.

The modulation region is divided into a plurality of regions (also referred to as tiling). A phase image is assigned to each of the plurality of tiles. Each of the plurality of tiles includes a plurality of pixels. A phase image related to a projected image is set to each of the plurality of tiles. A phase image is tiled to each of the plurality of tiles allocated to the modulation region. For example, a phase image generated in advance is set in each of the plurality of tiles. When the modulation region is irradiated with the illumination light in a state where the phase image is set to the plurality of tiles, the modulated light that forms an image related to the phase image of each tile is emitted. As the number of tiles set in the modulation region increases, a clear image can be displayed. However, when the number of pixels of each tile decreases, the resolution decreases. Therefore, the size and the number of tiles set in the modulation region are set according to the application.

A pattern (also referred to as a phase image) related to the image displayed by the spatial optical signal is set in each of the plurality of modulation regions under the control of the communication control device. A pattern (phase image) is set in each of the plurality of modulation regions. The illumination light with which each of the plurality of modulation regions is irradiated is modulated according to a pattern (phase image) set in the modulation region. The modulated light modulated in each of the plurality of modulation regions is transmitted as a spatial optical signal.

For example, a shielder (not illustrated) may be disposed at a stage subsequent to the spatial light modulator 453. The shielder is a frame that shields unnecessary light components included in the modulated light and defines an outer edge of a display region of the projection light. For example, the shielder is an aperture. In such an aperture, a slit-shaped opening is formed in a portion through which light (desired light) that forms a desired image passes. The desired light is first-order diffracted light. The shielder pass the desired light and shield unwanted light components. For example, the shielder shields a ghost image including 0th-order light included in the modulated light, and unnecessary first order light, and high order light above second order appearing at a point-symmetric position with respect to desired light with the 0th-order light as the center. Details of the shielder will not be described. For example, a projection lens (not illustrated) may be disposed at a stage subsequent to the spatial light modulator 453.

### [Communication Controller]

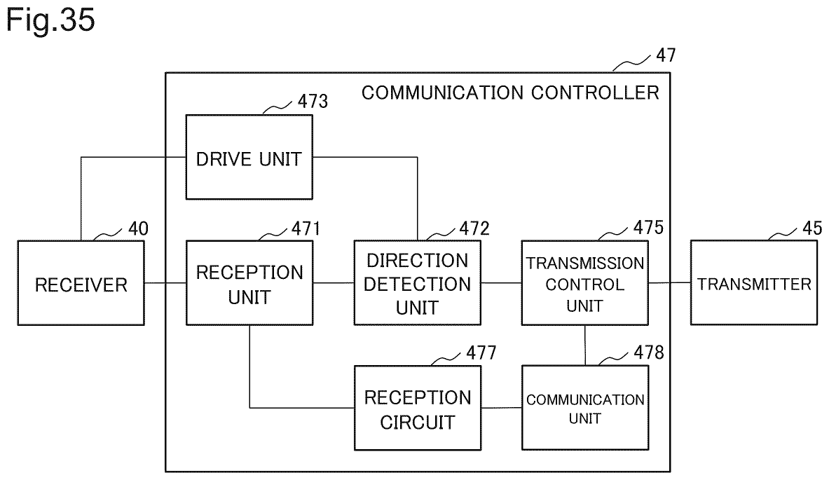

Next, a detailed configuration of the communication controller in the present example embodiment will be described with reference to the drawings. FIG. 35 is a block diagram illustrating an example of a configuration of a communication controller in the present disclosure. The communication controller 47 includes a reception unit 471, a direction detection unit 472, a drive unit 473, a transmission control unit 475, a reception circuit 477, and a communication unit 478. FIG. 35 illustrates an example of the configuration of the communication controller in the present disclosure, and does not limit the configuration of the communication controller. In the present example embodiment, processing such as direction detection of the incoming direction of the spatial optical signal based on the optical signal received by the direction detection light receiving element and the decoding of the communication signal based on the optical signal received by the communication light receiving element are executed by the communication controller 47. These processes may be configured to be executed by a detection circuit (not illustrated) included in the receiver 40.

The reception unit 471 has a configuration in which the first reception unit 171 and the second reception unit 176 in the first example embodiment are combined. The reception unit 471 is connected to the receiver 40. The reception unit 471 receives a signal from the receiver 40. The signal received by the reception unit 471 is derived from the optical signals received by the plurality of direction detection light receiving elements and the optical signal received by the communication light receiving element. The reception unit 471 outputs signals received from the plurality of direction detection light receiving elements to the direction detection unit 472. The reception unit 471 outputs the signal received from the communication light receiving element to the reception circuit 477. When the receiver 40 amplifies/AD-converts the signal received by the communication light receiving element, the reception unit 471 acquires the converted signal from the receiver.

The direction detection unit 472 acquires a signal derived from each of the plurality of direction detection light receiving elements. The direction detection unit 472 detects the incoming direction of the spatial optical signal according to the light receiving situation of the optical signal by each of the plurality of direction detection light receiving elements. The direction detection unit 472 generates a control signal for setting the moving direction and the moving amount of the light receiver according to the detected incoming direction of the spatial optical signal. For example, the direction detection unit 472 sets the moving direction and the moving amount of the light receiver using the method of the first example embodiment (see FIG. 14). The direction detection unit 472 generates a control signal for setting the transmission direction of the spatial optical signal by the transmitter 45 according to the position of the communication target. The direction detection unit 472 outputs the generated control signal to the drive unit 473 and the transmission control unit 475.

The drive unit 473 acquires a control signal for setting the moving direction and the moving amount of the light receiver from the direction detection unit 472. The drive unit 473 drives the vertical movement mechanism and the horizontal movement mechanism included in the moving support base included in the receiver 40 according to the acquired control signal. The drive unit 473 drives the vertical movement mechanism and the horizontal movement mechanism included in the moving support base to move the light receiver in the vertical plane and the horizontal plane.

The transmission control unit 475 controls the transmitter 45 according to the control signal output from the direction detection unit 472 to transmit a scanning spatial optical signal for establishing communication with the communication target. The transmission control unit 475 sets the scanning phase image in the modulation part 4530 of the spatial light modulator 453 included in the transmitter 45. The transmission control unit 475 controls the spatial light modulator 453 so that a parameter that determines a difference between the phase of the illumination light with which the modulation part 4530 is irradiated and the phase of the modulated light reflected by the modulation part 4530 changes. The transmission control unit 475 drives the light source 451 in a state where the scanning phase image is set in the modulation part 4530. As a result, the modulation part 4530 to which the scanning phase image is set is irradiated with the illumination light emitted from the light source 451. The modulated light modulated by the modulation part 4530 is projected as a spatial optical signal.

The transmission control unit 475 controls the transmitter 45 according to the communication information output from the communication unit 478 to transmit the communication spatial optical signal. The transmission control unit 475 modulates the illumination light emitted from the light source 451 in accordance with the content of the communication information output from the communication unit 478. In a state in which the communication phase image is set in the modulation part 4530 of the spatial light modulator 453, the transmission control unit 475 controls the timing at which the illumination light is emitted from the light source 451 in accordance with the communication content. By controlling the light source 451 in this manner, the illumination light emitted from the light source 451 is modulated in accordance with the content of the communication information.

The reception circuit 477 has a configuration similar to that of the reception circuit 177 in the first example embodiment. The reception circuit 477 acquires a signal derived from the optical signal received by the communication light receiving element. The reception circuit 477 amplifies the acquired signal. The reception circuit 477 converts the amplified signal from an analog signal to a digital signal. The reception circuit 477 outputs the converted digital signal to the communication unit 478. When a signal derived from an optical signal received by the communication light receiving element is used for direction detection, the reception circuit 477 may be configured to output the converted signal to the direction detection unit 472. When the signal derived from the optical signal received by the communication light receiving element is used for the direction detection, the accuracy of the direction detection can be further improved.

The communication unit 478 acquires the signal output from the reception circuit 477. The communication unit 478 decodes the acquired signal. The communication unit 478 generates communication information including the decoded information. The communication unit 478 outputs communication information including the decoded information to the transmission control unit 475. The communication unit 478 may be configured to output communication information including decoded information to the outside via a network such as the Internet. For example, the communication unit 478 may be configured to output communication information to a terminal device (not illustrated) used by an administrator who manages the communication device 4.

### (Application Example)

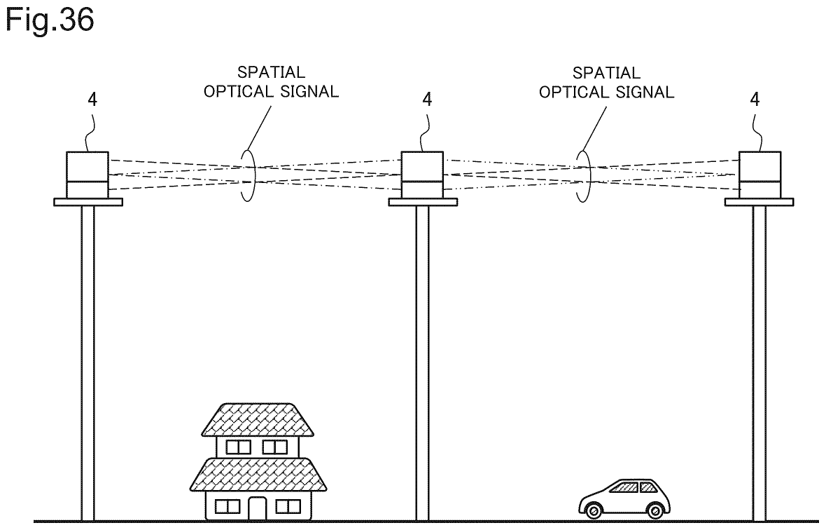

Next, the application example according to the present example embodiment will be described with reference to the drawings. In the following application example, an example in which a plurality of communication devices 4 transmits and receives spatial optical signals will be described. FIG. 36 is a conceptual diagram for describing an application of the communication device of the present disclosure. In the present application example, an example (communication system) of a communication network in which a plurality of communication devices 4 is provided on an upper portion (space above a pole) of a pole such as a utility pole or a street lamp disposed in a town.

There are few obstacles in the space above the pillar. Therefore, the space above the pillar is suitable for installing the communication device 4. When the communication device 4 is installed at the same height, the incoming direction of the spatial optical signal is limited to the horizontal direction. The pair of communication devices 4 that transmit and receive the spatial optical signal is disposed in such a way that at least one communication device 4 receives the spatial optical signal transmitted from the other communication device 4. The pair of communication devices 4 may be disposed to transmit and receive spatial optical signals to and from each other. In a case where the communication network of the spatial optical signal is configured by the plurality of communication devices 4, the communication device 4 positioned in the middle may be configured to relay the spatial optical signal transmitted from another communication device 4 to another communication device 4.

According to the present application example, communication using a spatial optical signal can be performed between the plurality of communication devices 4 each disposed in the space above the pillar. For example, communication by wireless communication may be performed between a wireless device installed in an automobile, a house or the like, or a base station and the communication device 4 according to communication between the communication devices 4. For example, the communication device 4 may be connected to the Internet via a communication cable or the like installed on a pillar.

As described above, the communication device of the present example embodiment includes the receiver, the transmitter, and the communication controller. The receiver is the receiver according to any one of the first to third example embodiments. The transmitter transmits a spatial optical signal. For example, the transmitter has a spatial light modulator. The communication controller controls the transmitter according to the optical signal detected by the receiver.

According to the receiver of the present example embodiment, the position of the light receiver can be accurately adjusted in accordance with the incoming direction of the spatial optical signal. According to the receiver of the present example embodiment, the transmission direction of the spatial optical signal can be controlled in accordance with the incoming direction of the spatial optical signal. That is, according to the present example embodiment, it is possible to establish spatial optical communication using a spatial optical signal with a communication target disposed in an any azimuth.

A communication system according to an aspect of the present example embodiment includes a plurality of the above-described communication device. A plurality of communication devices is disposed to transmit and receive the spatial optical signal to and from each other. According to the present aspect, it is possible to achieve a communication network that transmits and receives a spatial optical signal.

### Fifth Example Embodiment

Next, a receiver in a fifth example embodiment will be described with reference to the drawings. The receiver of the present example embodiment has a simplified configuration of the receivers of the first to third example embodiments. For example, the functions of the components included in the receiver in the present example embodiment are implemented by the functions of the components included in the receiver in the first to third example embodiments.

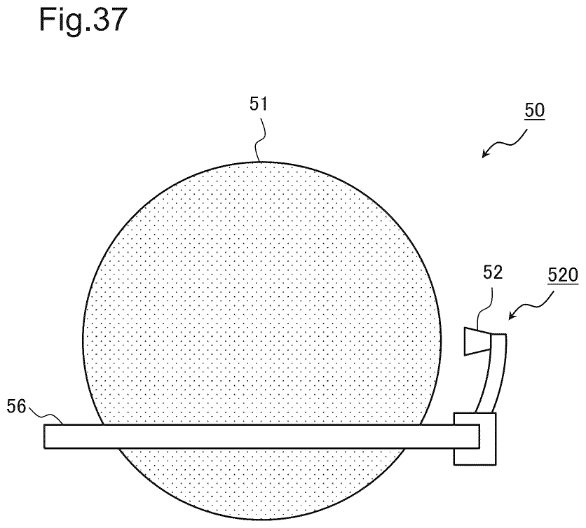

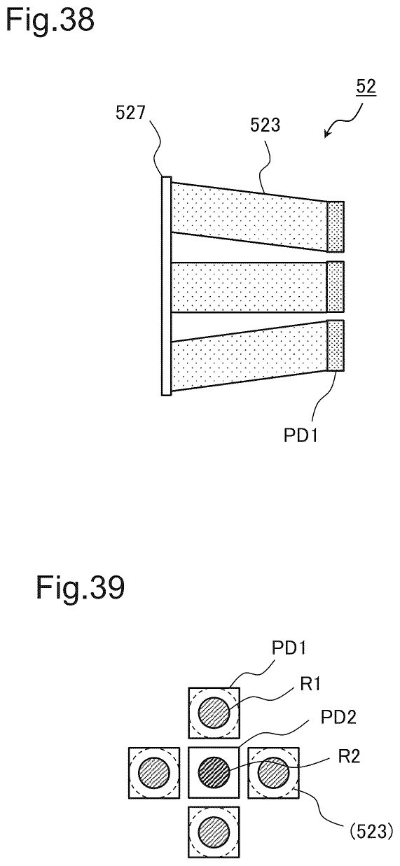

FIG. 37 to FIG. 39 are conceptual diagrams illustrating an example of a configuration of a receiver in the present disclosure. FIG. 37 is a conceptual diagram of the receiver when viewed from a side. FIG. 38 is a conceptual diagram of the receiver when viewed from above. FIG. 39 is a view of the light receiver when viewed from the ball lens with some of the components of the light receiver removed.

A receiver 50 includes a ball lens 51, an annular track 56, and at least one movable light receiver 520. The annular track 56 is disposed in such a way as to surround the lower portion of the ball lens 51. The movable light receiver 520 includes a light receiver 52 movably installed in a direction perpendicular to the annular track 56. The movable light receiver 520 is movably disposed along the outer periphery of the annular track 56.

The light receiver 52 includes the communication light receiving element PD2, the plurality of direction detection light receiving elements PD1, a wavelength filter 527, and an optical waveguide 523. The communication light receiving element PD2 is disposed with the light reception part R2 facing the ball lens 51. The plurality of direction detection light receiving elements PD1 is annularly disposed around the communication light receiving element PD2 with the light reception part R1 facing the ball lens. The wavelength filter 527 is disposed between the ball lens 51 and the communication light receiving element PD2, and between the ball lens 51 and the plurality of direction detection light receiving elements PD1. The wavelength filter 527 passes light in a wavelength band of a spatial optical signal to be communicated. The optical waveguide 523 is disposed in association with each of the plurality of direction detection light receiving elements PD1. The optical waveguide 523 guides the optical signal condensed by the ball lens 51 to the direction detection light receiving element PD1.

The receiver of the present example embodiment can accurately detect the incoming direction of the spatial optical signal by the irradiation range of the optical signal detected by the plurality of direction detection light receiving elements. The receiver of the present example embodiment includes a movable light receiver movably disposed along the outer periphery of the annular track. The movable light receiver includes a light receiver movably installed in a direction perpendicular to the annular track. The position of the light receiver in the horizontal plane can be accurately adjusted by moving the light receiver along the outer periphery of the annular track. The position of the light receiver in the vertical plane can be accurately adjusted by moving the light receiver in a direction perpendicular to the annular track. That is, according to the present example embodiment, the position of the light receiver can be accurately adjusted in accordance with the incoming direction of the spatial optical signal.

### (Hardware)

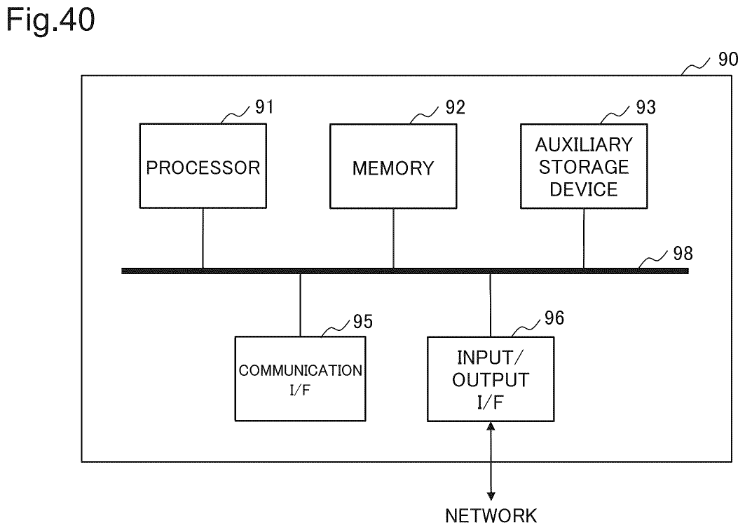

Next, a hardware configuration for executing control and processing in the present disclosure will be described with reference to the drawings. An example of such a hardware configuration is an information processing device 90 (computer) in FIG. 40. The information processing device 90 in FIG. 40 is a configuration example for executing control and processing in the present disclosure, and does not limit the scope of the present disclosure.

As illustrated in FIG. 40, the information processing device 90 includes a processor 91, a memory 92, an auxiliary storage device 93, an input/output interface 95, and a communication interface 96. In FIG. 40, the interface is abbreviated as an interface (I/F). The processor 91, the memory 92, the auxiliary storage device 93, the input/output interface 95, and the communication interface 96 are data-communicably connected to each other via a bus 98. The processor 91, the memory 92, the auxiliary storage device 93, and the input/output interface 95 are connected to a network such as the Internet or an intranet via the communication interface 96.

The processor 91 develops a program (instruction) stored in the auxiliary storage device 93 or the like in the memory 92. For example, the program is a software program for executing control and processing in the present disclosure. The processor 91 executes the program developed in the memory 92. The processor 91 executes control and processing in the present disclosure by executing a program.

The memory 92 is a storage device having an area in which a program is developed. A program stored in the auxiliary storage device 93 or the like is developed in the memory 92 by the processor 91. The memory 92 is achieved by, for example, a volatile memory such as a dynamic random access memory (DRAM). A nonvolatile memory such as a magnetoresistive random access memory (MRAM) may be applied as the memory 92.

The auxiliary storage device 93 stores various pieces of data such as programs. For example, the auxiliary storage device 93 is achieved by a local disk such as a hard disk or a flash memory. Various pieces of data may be stored in the memory 92, and the auxiliary storage device 93 may be omitted.

The input/output interface 95 is an interface that connects the information processing device 90 with a peripheral device based on a standard or a specification. The communication interface 96 is an interface that connects to an external system or a device through a network such as the Internet or an intranet in accordance with a standard or a specification. As an interface connected to an external device, the input/output interface 95 and the communication interface 96 may be shared.

An input device such as a keyboard, a mouse, or a touch panel may be connected to the information processing device 90 as necessary. These input devices are used to input of information and settings. In a case where a touch panel is used as the input device, a screen having a touch panel function serves as an interface. The processor 91 and the input device are connected via the input/output interface 95.

The information processing device 90 may be provided with a display device that displays information. In a case where a display device is provided, the information processing device 90 includes a display control device (not illustrated) that controls display of the display device. The information processing device 90 and the display device are connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of a hardware configuration for enabling control and processing in the present disclosure. The hardware configuration of FIG. 40 is an example of a hardware configuration for executing control and processing in the present disclosure, and does not limit the scope of the present disclosure. A program for causing a computer to execute control and processing in the present disclosure is also included in the scope of the present disclosure.

A program recording medium in which a program for executing processing in the present example embodiment is recorded is also included in the scope of the present invention. For example, the program recording medium is a computer-readable non-transitory recording medium. The recording medium can be achieved by, for example, an optical recording medium such as a compact disc (CD) or a digital versatile disc (DVD). The recording medium may be achieved by a semiconductor recording medium such as a Universal Serial Bus (USB) memory or a secure digital (SD) card. The recording medium may be achieved by a magnetic recording medium such as a flexible disk, or another recording medium.

The components in the present disclosure may be combined in any manner. The components in the present disclosure may be implemented by software. The components in the present disclosure may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

Some or all of the above example embodiments may be described as the following Supplementary Notes, but are not limited to the following.

### (Supplementary Note 1)

A receiver including
a ball lens,
an annular track disposed in such a way as to surround a lower portion of the ball lens, and
at least one movable light receiver having a light receiver movably installed in a direction perpendicular to the annular track and movably disposed along an outer periphery of the annular track, wherein the light receiver includes
a communication light receiving element disposed with a light reception part facing the ball lens,
a plurality of direction detection light receiving elements disposed in an annular shape with the communication light receiving element as a center with the light reception part facing the ball lens,
a wavelength filter that is disposed between the communication light receiving element and the ball lens, and between the plurality of direction detection light receiving elements and the ball lens, and passes light in a wavelength band of a spatial optical signal to be communicated, and
an optical waveguide that is disposed in association with each of the plurality of direction detection light receiving elements and guides an optical signal condensed by the ball lens to the direction detection light receiving element.

### (Supplementary Note 2)

The receiver according to claim 1, wherein
the optical waveguide includes
an optical fiber capable of transmitting light in a wavelength band of a spatial optical signal to be communicated,
an incident end of the optical waveguide
is connected to the wavelength filter, and
an emission end of the optical waveguide
is connected to a light reception part of each of the plurality of direction detection light receiving elements.

### (Supplementary Note 3)

The receiver according to claim 2, wherein
the movable light receiver includes
a moving support base movably installed along an outer periphery of the annular track, and
a curved support column that curves in an arc shape along a circumference of a circle centered on a center point of the ball lens, is erected on an upper portion of the moving support base, and movably supports the light receiver along the circumference of the circle centered on the center point of the ball lens.

### (Supplementary Note 4)

The receiver according to claim 3, wherein the communication light receiving element and the plurality of direction detection light receiving elements are disposed on a same face of a same substrate disposed in a condensing region of the ball lens.

### (Supplementary Note 5)

The receiver according to claim 3, wherein
the communication light receiving element
is disposed on a substrate disposed in a condensing region of the ball lens,
the plurality of direction detection light receiving elements
is disposed on a substrate disposed at a position away from the condensing region of the ball lens, and
the optical waveguide
extends to a substrate on which the plurality of direction detection light receiving elements is disposed.

### (Supplementary Note 6)

The receiver according to Supplementary Note 3, wherein
the movable light receiver includes
a communication light guide that is disposed in a condensing region of the ball lens and guides an optical signal condensed by the ball lens, and
a communication optical waveguide that connects a light reception part of the communication light receiving element and the communication light guide, and guides the optical signal guided by the communication light guide to the communication light receiving element,
the communication light receiving element and the plurality of direction detection light receiving elements
are disposed at a position away from a condensing region of the ball lens, and
the optical waveguide and the communication optical waveguide
extend to a substrate on which the communication light receiving element and the plurality of direction detection light receiving elements are disposed.

### (Supplementary Note 7)

The receiver according to claim 6, wherein
the moving support base includes
a horizontal movement mechanism that moves the light receiver along a circumference of a circle centered on a center point of the ball lens in a horizontal plane along an outer periphery of the annular track and
a vertical movement mechanism that moves the light receiver along a circumference of the circle centered on the center point of the ball lens in a vertical plane perpendicular to the horizontal plane.

### (Supplementary Note 8)

The receiver according to Supplementary Note 2, further including
a communication controller that acquires an electric signal derived from an optical signal received by each of the communication light receiving element and the plurality of direction detection light receiving elements included in the light receiver, wherein
the communication controller
detects an incoming direction of a spatial optical signal according to an electric signal derived from an optical signal received by each of the plurality of direction detection light receiving elements,
outputs information about the incoming direction of the detected spatial optical signal,
decodes the electric signal derived from the optical signal received by the communication light receiving element, and
outputs decoded information.

### (Supplementary Note 9)

The receiver according to Supplementary Note 7, further including
a communication controller that acquires an electric signal derived from an optical signal received by each of the communication light receiving element and the plurality of direction detection light receiving elements included in the light receiver, wherein
the communication controller
detects an incoming direction of a spatial optical signal according to an electric signal derived from an optical signal received by each of the plurality of direction detection light receiving elements,
moves the horizontal movement mechanism and the vertical movement mechanism included in the moving support base in such a way that a light receiving face of the light receiver faces an incoming direction of the detected spatial optical signal,
decodes the electric signal derived from the optical signal received by the communication light receiving element, and
outputs decoded information.

### (Supplementary Note 10)

A communication device including
the receiver according to any one of Supplementary Notes 1 to 7,
a transmitter that transmits a spatial optical signal, and
a communication controller that controls the transmitter according to an optical signal detected by the receiver.

Some or all of the configurations described in Supplementary Notes 2 to 9 dependent on the above-described Supplementary Note 1 can also depend on Supplementary Note 10 by the same dependency relationship as in Supplementary Notes 2 to 9.

1. A receiver comprising:
a ball lens;
an annular track disposed in such a way as to surround a lower portion of the ball lens; and
at least one movable light receiver having a light receiver movably installed in a direction perpendicular to the annular track and movably disposed along an outer periphery of the annular track, wherein
the light receiver includes
a communication light receiving element disposed with a light reception part facing the ball lens,
a plurality of direction detection light receiving elements disposed in an annular shape with the communication light receiving element as a center with the light reception part facing the ball lens,
a wavelength filter that is disposed between the communication light receiving element and the ball lens, and between the plurality of direction detection light receiving elements and the ball lens, and passes light in a wavelength band of a spatial optical signal to be communicated, and
an optical waveguide that is disposed in association with each of the plurality of direction detection light receiving elements and guides an optical signal condensed by the ball lens to the direction detection light receiving element.

2. The receiver according to claim 1, wherein
the optical waveguide includes an optical fiber capable of transmitting light in a wavelength band of a spatial optical signal to be communicated,
an incident end of the optical waveguide is connected to the wavelength filter, and
an emission end of the optical waveguide is connected to a light reception part of each of the plurality of direction detection light receiving elements.

3. The receiver according to claim 2, wherein
the movable light receiver includes
a moving support base movably installed along an outer periphery of the annular track, and
a curved support column that curves in an arc shape along a circumference of a circle centered on a center point of the ball lens, is erected on an upper portion of the moving support base, and movably supports the light receiver along the circumference of the circle centered on the center point of the ball lens.

4. The receiver according to claim 3, wherein
the communication light receiving element and the plurality of direction detection light receiving elements are disposed on a same face of a same substrate disposed in a condensing region of the ball lens.

5. The receiver according to claim 3, wherein
the communication light receiving element is disposed on a substrate disposed in a condensing region of the ball lens,
the plurality of direction detection light receiving elements is disposed on a substrate disposed at a position away from the condensing region of the ball lens, and
the optical waveguide extends to a substrate on which the plurality of direction detection light receiving elements is disposed.

6. The receiver according to claim 3, wherein
the movable light receiver includes
a communication light guide that is disposed in a condensing region of the ball lens and guides an optical signal condensed by the ball lens, and
a communication optical waveguide that connects a light reception part of the communication light receiving element and the communication light guide, and guides the optical signal guided by the communication light guide to the communication light receiving element,
the communication light receiving element and the plurality of direction detection light receiving elements are disposed at a position away from a condensing region of the ball lens, and
the optical waveguide and the communication optical waveguide extend to a substrate on which the communication light receiving element and the plurality of direction detection light receiving elements are disposed.

7. The receiver according to claim 6, wherein
the moving support base includes
a horizontal movement mechanism that moves the light receiver along a circumference of a circle centered on a center point of the ball lens in a horizontal plane along an outer periphery of the annular track and
a vertical movement mechanism that moves the light receiver along a circumference of the circle centered on the center point of the ball lens in a vertical plane perpendicular to the horizontal plane.

8. The receiver according to claim 2, further comprising:
a communication controller that comprises
a memory storing instructions; and
a processor connected to the memory and configured to execute the instructions to
acquire an electric signal derived from an optical signal received by each of the communication light receiving element and the plurality of direction detection light receiving elements included in the light receiver, wherein
the processor of the communication controller is configured to execute the instructions to
detect an incoming direction of a spatial optical signal according to an electric signal derived from an optical signal received by each of the plurality of direction detection light receiving elements,
output information about the incoming direction of the detected spatial optical signal,
decode the electric signal derived from the optical signal received by the communication light receiving element, and
output decoded information.

9. The receiver according to claim 7, further comprising:
a communication controller that comprises
a memory storing instructions; and
a processor connected to the memory and configured to execute the instructions to
acquire an electric signal derived from an optical signal received by each of the communication light receiving element and the plurality of direction detection light receiving elements included in the light receiver, wherein
the processor of the communication controller is configured to execute the instructions to
detect an incoming direction of a spatial optical signal according to an electric signal derived from an optical signal received by each of the plurality of direction detection light receiving elements,
move the horizontal movement mechanism and the vertical movement mechanism included in the moving support base in such a way that a light receiving face of the light receiver faces an incoming direction of the detected spatial optical signal,
decode the electric signal derived from the optical signal received by the communication light receiving element, and
output decoded information.

10. A communication device comprising:
the receiver according to claim 1;
a transmitter that transmits a spatial optical signal; and
a communication controller that controls the transmitter according to an optical signal detected by the receiver.
